(19) United States
(12) Patent Application Publication
(10) Pub. No.: US 2013/0246724 A1
(43) Pub. Date: Sep. 19, 2013

(54) BACKUP DEVICE, METHOD OF BACKUP, AND COMPUTER-READABLE RECORDING MEDIUM HAVING STORED THEREIN PROGRAM FOR BACKUP

(71) Applicant: FUJITSU LIMITED, Kawasaki-shi (JP)

(72) Inventor: Masanori FURUYA, Kawasaki (JP)

(73) Assignee: FUJITSU LIMITED, Kawasaki-shi (JP)

(21) Appl. No.: 13/762,435

(22) Filed: Feb. 8, 2013

(30) Foreign Application Priority Data
Mar. 19, 2012 (JP) 2012-061930

(51) Int. Cl. G06F 3/06

(52) U.S. Cl. CPC G06F 3/0655
USPC 711/162

(57) ABSTRACT

A backup device that generates a backup volume of an object volume, the backup device includes: a first storage device that stores data of the backup volume; and a processor that generates, upon receipt of an instruction of generating the backup volume, the backup volume by copying data of the object volume into a first region of the first storage device, moves the data of the backup volume, the data being stored in the first region of the first storage device, to a second region of the first storage device, the second region being subordinate to the first region, and releases, upon receipt of an instruction of generating the backup volume under a state where the data of the backup volume is stored in the second region, the data of the backup volume from the second region.

### CROSS-REFERENCE TO RELATED APPLICATION

This application is based upon and claims the benefit of priority of the prior Japanese Patent Application No. 2012-061930, filed on Mar. 19, 2012, the entire contents of which are incorporated herein by reference.

### FIELD

The embodiment discussed herein is a backup device, a method of backup, and a computer-readable recording medium having stored therein a program for backup.

### BACKGROUND

Some storage systems adopt a storage virtualization function that virtualizes the storage resource to reduce the physical capacity of the storage. Accompanying drawing FIG. 34A is a diagram illustrating an example of allocation of storage of the storage virtualization function and FIG. 34B is a diagram illustrating an example of releasing of storage of the storage virtualization function.

As illustrated in FIG. 34A, the storage virtualization function generates a logical volume, not associating the logical volume with physical disks in a storage pool, and, when a host device issues a request such as a write I/O to write data into the logical volume, dynamically allocates resource (physical capacity) from the storage pool. Furthermore, as illustrated in FIG. 34B, the storage virtualization function releases, in volume formatting or in response to an initialization command from the host device, unnecessary resource allocated to the logical volume in the storage pool.

Here, some storage systems use, as physical disks, Solid State Drives (SSDs) capable of high-speed access and inexpensive large-capacity disks compatible with Serial Advanced Technology Attachment (SATA) in combination. Such systems rise the using efficiency of SSDs higher in price than SATA disks and enhance the performance of the entire system by layering SSDs and SATA disks and storing data frequently accessed into the SSDs and data less frequently accessed into the SATA disks. Such a system can also reduce the costs.

In layering physical disks having different access speeds, a storage system carries out automatic layering of storage in which the arrangement of physical data is changed so as to optimize the performance of the entire system. FIG. 35 is a diagram illustrating an example of a scheme of automatic layering of storage, and FIG. 36 is a diagram illustrating an example of rearranging data in a layered storage pool.

As illustrated in FIG. 35, the storage system collects performance information such as access frequencies to data and response capability in the volume (physical disks) and analyzes the collected information by means of automatic layering of storage. On the basis of the result of the analysis, the storage system determines a plan of physical rearrangement of data so as to optimize the performance of the entire system, and rearranges the data according to the plan.

Here, description will be made in relation to an example of, as illustrated in FIG. 36, a storage pool having the layering of, in the order of higher accessing speeds, an SSD, a disk compatible with Fibre Channel (FC), and an SATA disk. The example assumes that data a and data b in the logical volume are associated with the FC disk and data c in the logical volume is associated with the SATA disk. To begin with, the storage system collects and analyzes the performance information through automatic layering of storage. If the analysis concludes that the data a and data c are frequently accessed, the data a is moved from Tier FC to a high-access-speed layer Tier SSD and similarly moves the data c from Tier SATA to the Tier SSD. In addition, if the analysis concludes that the data b is less frequently accessed, the storage system moves the data b from Tier FC to a low-access-speed layer Tier SATA.

An OPC (One Point Copy) scheme is known as one of the methods of backing up a copy-source volume, such as work volume, in a storage system such as a storage product or a computer. OPC is a technique of generating a snapshot, which contains object data of a certain time point. Upon receipt of an instruction of starting OPC from a user, the storage system copies the entire data of the work volume at the time point of the receipt of the instruction in the background and stores the copied data, that is, a snapshot (backup data), so that the work volume is backed up.

In the OPC scheme, if a request of updating, for example, writing data, a region of the work volume into which background copy is not completed is issued, the storage system accomplishes the copy of the data of the region in question before the updating takes place. If a request of referring or updating a backup volume into which background copy is not completed is issued, the storage system first accomplishes the data copy to the region of the backup volume and then refers to or updates the requested region. The OPC instantly enables both the work volume and the backup volume to be referred and updated as if the generation of the backup volume is completed concurrently with responding to the instruction of starting OPC.

This OPC scheme is extended to schemes of QOPC (Quick One Point Copy) that copies difference data and SnapOPC+ (Snapshot One Point Copy+) that copies data of multiple generations.

The QOPC scheme generates a backup volume of the work volume at a certain time point the same as the OPC scheme but, after the background copy, stores data updated from the immediately-previous backup, differently from the OPC scheme. For the above, the QOPC scheme may generate backup volumes for the second and subsequent times, that is, may restart the backup, simply by copying difference data in the background.

The SnapOPC+ scheme accomplishes copying of the work volume, not allocating a volume as much as the work volume. Specifically, the SnapOPC scheme does not copy the entire work volume, and in the event of updating the work volume, copies data (previous data) before the updating but subjected to the updating into the backup volume serving as a copy destination. As the above, since the SnapOPC+ scheme copies data updated in the work volume, data redundancy among multiple generations can be avoided, which makes it possible to reduce the capacity of disks to be used for a backup volume.

Besides, if the server makes an access to the backup volume serving as the copy destination and if data copying to the region to be accessed is not completed, the SnapOPC+ scheme causes the server to refer to data in the work volume instead, the data being to be copied to the region to be accessed in the backup volume. The SnapOPC+ can generate backup volumes of multiple generations due to the preparation of multiple backup volumes.

An EC (Equivalent Copy) scheme is also known as another scheme to back up a work volume. The EC scheme generates a snapshot by mirroring data between a work volume and a backup volume and at a certain time point suspending the mirroring. In the event of updating the work volume in the mirroring state, the EC scheme copies data updated in the work volume into the backup volume. The EC scheme restarts the mirroring through resuming. The background copy performed during the resuming is accomplished by copying only data updated during the suspending.

Furthermore, another known scheme is an REC (Remote Equivalent Copy) scheme, which carries out the mirroring the same as that of the EC scheme between storage systems.

One of the related techniques generates a data snapshot by a storage server and moves a change in the data snapshot from a high layer to a low layer.

Another related technique forms multiple storage layers by a volume group in accordance with the respective policies (e.g., high reliability, low cost, archive), and when a user assigns a volume to be moved in units of groups and assigns a storage layer at the moving destination, rearranges data.
[Patent Literature 1] Japanese Laid-open Patent Publication No. 2010-146586
[Patent Literature 2] Japanese Laid-open Patent Publication No. 2006-99748

As the above, automatic layering of storage moves data frequently accessed to a high-access-speed storage layer (disk) such as an SSD while moves data less frequently accessed to an inexpensive relatively-low-access-speed storage layer, which is large in capacity, such as a Nearline HDD (Hard Disk Drive). In this manner, the storage system measures performance information such as access frequency of each piece of data before the rearrangement, which makes it difficult to immediately respond to a change in performance information.

For example, description will now be made assuming that a backup volume is generated in a storage pool subjected to the automatic layering of storage in a backup scheme such as the OPC. If the data in the backup volume is not frequently accessed, the automatic layering of storage rearranges the backup volume from a region of a high-access-speed storage layer such as an SSD to a region of a low-access-speed storage layer such as an SATA disk. At that time, the backup of the work volume serving as the copy source is started or restarted, and the data of the work volume is backed up into a backup volume moved to a lower-access-speed layer. For example, if the backup volume is stored in a layer lower in access speed than the layer that stores the work volume serving as the copy source, the access speed to the backup volume comes to be lower than that to the work volume, which impairs the performance of the entire storage system.

Here, there is a possibility that the automatic layering of storage rearranges the backup volume to a higher-access-speed layer in accordance with rise of access frequency to the backup volume in the course of the backup. However, the storage system rearranges data according to the result of measuring and analyzing performance information of each piece of data as described above, which makes it difficult to immediately respond to the timing of starting or restarting the backup of the work volume serving as the copy source. Even in the case of the above rearrangement to a high-access-speed layer, the performance of the entire system is still affected.

The above related techniques do not assume a case of starting and restarting backup of the work volume serving as a copy source under a state where the backup volume is arranged in a low-access-speed layer.

### SUMMARY

According to an aspect of the embodiment, a backup device generates a backup volume of an object volume, the backup device including: a first storage device that stores data of the backup volume; and a processor that generates, upon receipt of an instruction of generating the backup volume, the backup volume by copying data of the object volume into a first region of the first storage device, moves the data of the backup volume, the data being stored in the first region of the first storage device, to a second region of the backup device, the second region being subordinate to the first region, and releases, upon receipt of an instruction of generating the backup volume under a state where the data of the backup volume is stored in the second region, the data of the backup volume from the second region.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram schematically illustrating an example of the configuration of a storage system applied to a backup device of a first embodiment;

FIG. 2 is a diagram illustrating an example of a backup scheme of a backup device of the first embodiment;

FIG. 3 is a diagram illustrating an example of a functional configuration of a backup device of the first embodiment;

FIG. 4 is a diagram depicting an example of a data structure of an allocation management table managed by a CM of the first embodiment;

FIG. 5 is a diagram depicting an example of an updating management table managed by a CM of the first embodiment;

FIGS. 6A and 6B are diagrams illustrating a procedure of moving a backup volume through OPC/QOPC by a backup device of the first embodiment;

FIG. 7 is a diagram illustrating a procedure of allocating a backup volume by a backup device of the first embodiment;

FIGS. 8A and 8B are diagrams illustrating an example of a procedure of releasing a backup volume through OPC by a backup device of the first embodiment;

FIGS. 9A and 9B are diagrams illustrating an example of a procedure of releasing a backup volume through QOPC by a backup device of the first embodiment;

FIGS. 10A and 10B are diagrams illustrating an example of a procedure of moving a backup volume through SnapOPC+ by a backup device of the first embodiment;

FIGS. 11A and 11B are diagrams illustrating an example of a procedure of releasing a backup volume through SnapOPC+ by a backup device of the first embodiment;

FIGS. 12A and 12B are diagrams illustrating an example of moving a backup volume through EC/REC by a backup device of the first embodiment;

FIGS. 13A and 13B are diagrams illustrating an example of allocating a backup volume through EC/REC by a backup device of the first embodiment;

FIGS. 14A and 14B are diagrams illustrating an example of releasing a backup volume through EC/REC by a backup device of the first embodiment;

FIGS. 15A-15D are diagrams illustrating an example of a procedure of determining a generation to be released through SnapOPC+ by a releaser of the first embodiment;

FIG. 16 is a flow diagram denoting an example of a succession of procedural steps of generating a backup volume through OPC/QOPC of the first embodiment;

FIG. 17 is a flow diagram denoting an example of a succession of procedural steps of releasing a backup volume through OPC of the first embodiment;

FIG. 18 is a flow diagram denoting an example of a succession of procedural steps of allocating a backup volume of the first embodiment;

FIG. 19 is a flow diagram denoting an example of a succession of procedural steps of moving a backup volume through OPC/QOPC of the first embodiment;

FIG. 20 is a flow diagram denoting an example of a succession of procedural steps of generating a backup volume through QOPC for the second and subsequent times of the first embodiment;

FIG. 21 is a flow diagram denoting an example of a succession of procedural steps of releasing a backup volume through QOPC of the first embodiment;

FIG. 22 is a flow diagram denoting an example of a succession of procedural steps of generating a backup volume through SnapOPC+ of the first embodiment;

FIG. 23 is a flow diagram denoting an example of a succession of procedural steps of moving a backup volume through SnapOPC+ of the first embodiment;

FIG. 24 is a flow diagram denoting an example of a succession of procedural steps of releasing a backup volume through SnapOPC+ of the first embodiment;

FIG. 25 is a flow diagram denoting an example of a succession of procedural steps of generating a backup volume through EC/REC of the first embodiment;

FIG. 26 is a flow diagram denoting an example of a succession of procedural steps of mirroring through EC/REC of the first embodiment;

FIG. 27 is a flow diagram denoting an example of a succession of procedural steps of suspending through EC/REC of the first embodiment;

FIG. 28 is a flow diagram denoting an example of a succession of procedural steps of resuming through EC/REC of the first embodiment;

FIG. 29 is a flow diagram denoting an example of a succession of procedural steps of allocating a backup volume through EC/REC of the first embodiment;

FIG. 30 is a flow diagram denoting an example of a succession of procedural steps of moving a backup volume through EC/REC of the first embodiment;

FIG. 31 is a flow diagram denoting an example of a succession of procedural steps of releasing and moving a backup volume through EC/REC of the first embodiment;

FIG. 32 is a flow diagram denoting a succession of procedural steps of moving a backup volume according to a modification of the first embodiment;

FIG. 33 is a flow diagram denoting a succession of procedural steps of moving a backup volume by a backup device according to a modification of the first embodiment;

FIG. 34A is a diagram illustrating an example of a procedure of allocating storage through a storage virtualization function;

FIG. 34B is a diagram illustrating an example of a procedure of releasing storage through a storage virtualization function;

FIG. 35 is a diagram illustrating an example of a scheme of automatic layering of storage; and

FIG. 36 is a diagram illustrating an example of rearranging data in a layered storage pool.

### DESCRIPTION OF EMBODIMENTS

Hereinafter, description will now be made in relation to a first embodiment with reference to accompanying drawings.

### (1) First Embodiment

(1-1) Example of the Configuration of a Storage System:

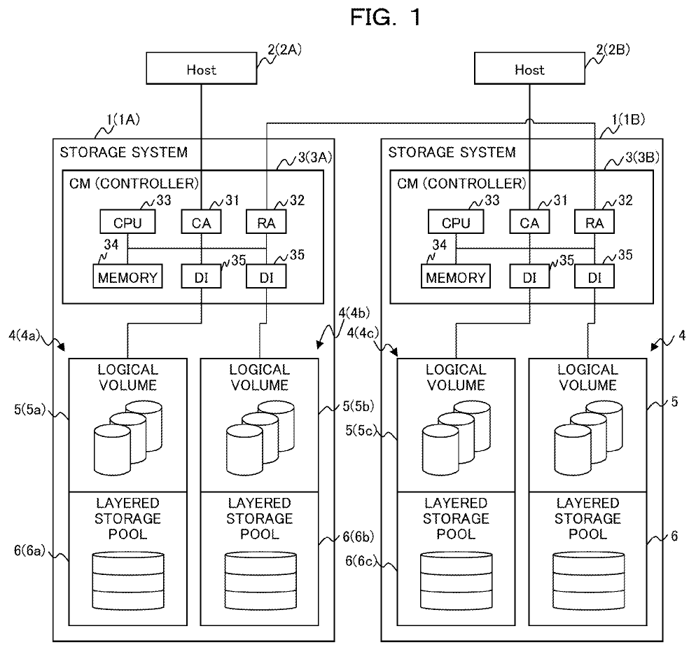

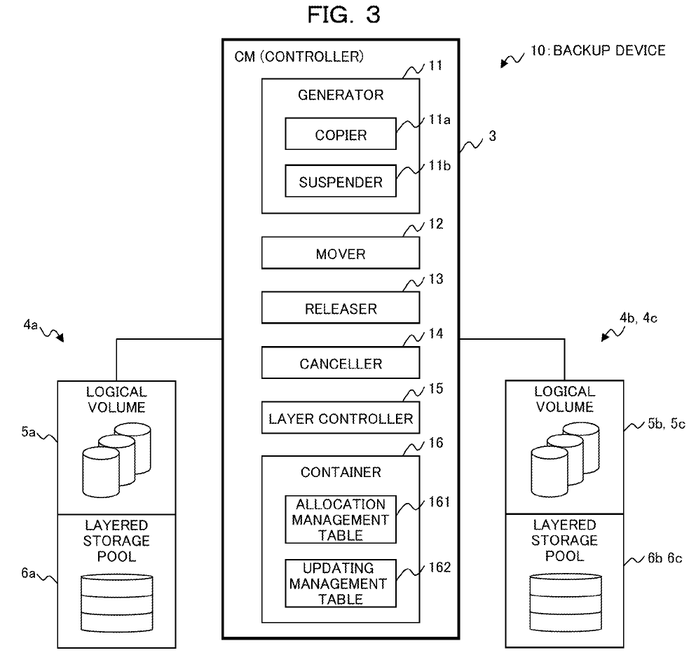

FIG. 1 is a block diagram schematically illustrating the configuration of a storage system 1 to which a backup device 10 (see FIG. 3) of the first embodiment is applied.

As illustrated in FIG. 1, the storage system 1 is coupled to a host computer 2 (Host, hereinafter called a host device), and receives various requests from the host device 2 and carries out various processes according to the requests.

FIG. 1 illustrates two storage systems 1 (1A and 1B) the same or substantially same in configuration and two host devices 2 (2A and 2B) coupled to the storage systems 1A and 1B, respectively. FIG. 1 illustrates two independent host devices 2A and 2B, but alternatively a single host device 2 may be coupled to two storage systems 1A and 1B and may issue various requests to the storage systems. Hereinafter, when the storage systems 1A and 1B are not discriminated from each other, these storage systems are simply referred to as the storage system(s) 1 or the system(s) 1. Similarly, when the host devices 2A and 2B are not discriminated form each other, these devices are referred to as the host device(s) 2.

Each storage device 1 includes a Controller Module (hereinafter called CM) 3 and a multiple (two in FIG. 1) storage devices 4.

The CM 3 is coupled to the host device 2, two storage devices 4, and the CM 3 of another system 1, and manages the resource of the storage system 1. The CM (controller) 3 carries out various processes (e.g., data writing, data updating, data reading, and data copying) on two storage devices 4 in response to requests from the host device 2 or the CM 3 of the other system 1. The CM 3 further has a storage virtualization function, which makes it possible to reduce a physical capacity of storage in the storage devices 4, and another function of automatic rearranging storage, which improves performance of the entire system and also reduces cost.

In each storage system 1 of FIG. 1, one CM is provided for multiple storage devices 4, but alternatively, one CM 3 may be provided for each storage device 4. In the latter case, such multiple CMs 3 are coupled to one another via, for example, buses, so that each CM 3 is configured to be accessible to storage devices 4 coupled to the remaining CMs 3. Alternatively, for the purpose of redundancy, each CM 3 may be configured to be directly accessible to the multiple storage devices 4.

The storage devices 4 (4a-4c) each store and hold user data and control data and each include a logical volume 5 (5a-5c) that the host device 2 can recognize, a layered storage pool 6 (6a-6c) serving as a pool of a physical capacity allocated to the logical volume 5. The storage devices 4a-4c (the logical volumes 5a-5c and the layered storage pools 6a-6c) have the same or substantially same in configuration. Hereinafter, when the storage devices 4a-4c are not discriminated from one another, either storage device is represented by a reference number “4”. In the same manner, the logical volumes 5a-5c and the layered storage pools 6a-6c are represented by reference numbers “5” and “6”, respectively.

Each logical volume 5 is at least one virtual volume managed by the storage virtualization function of the storage system 1. The host device 2 recognizes the logical volume 5 as at least one virtual volume and issues, to the storage system 1, various requests for processes to be performed on storage regions (logical data regions) specified by logical addresses of the logical volume 5.

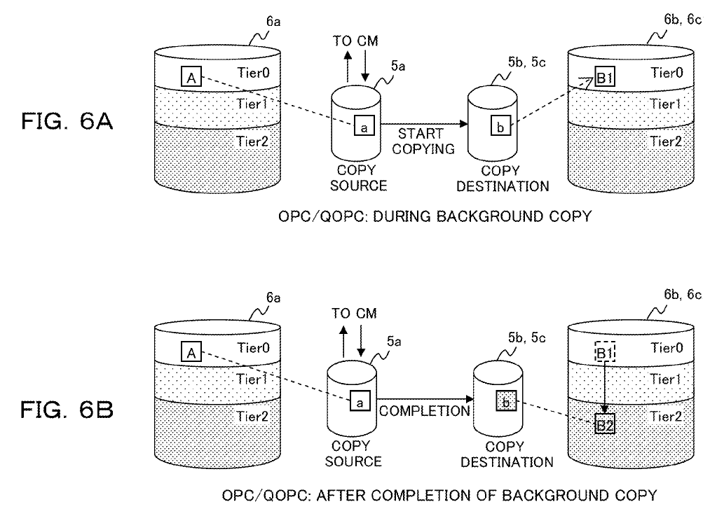

Each layered storage pool 6 is a storage device formed of multiple physical disks (physical volumes) and has a layered form according to the performance, such as access speeds and physical capacities, of the physical disks and also to the cost. Here, the physical disks are exemplified by magnetic disk devices such as HDDs and semiconductor disk devices such as SSDs, which serve as hardware to store various data and programs. Hereinafter, each layered storage pool 6 has a layered form including in the higher order an SSD layer (Tier 0); an FC layer (Tier 1); and an SATA layer (Tier 2). In the layered storage pool 6, a higher physical disk is a physical disk having a higher accessing speed (see FIGS. 6A through 14B).

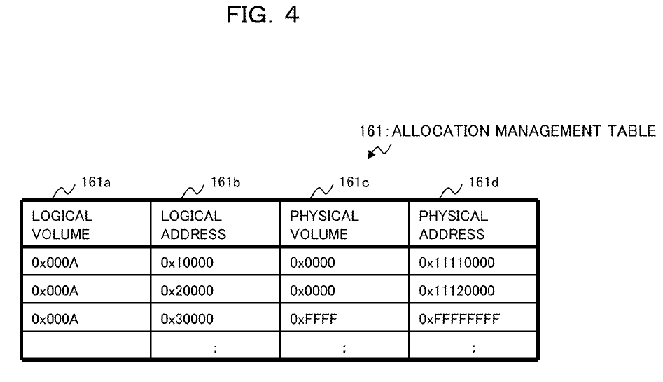

Each logical address of the logical volume 5 is associated with a physical address of a physical volume of the corresponding layered storage pool 6 in an allocation management table 161 (see FIGS. 3 and 4) to be detailed below, and is managed by the CM 3. Upon receipt of a request for a process to be performed on a certain logical address of the logical volume 5 from the host device 2, the CM 3 refers to the allocation management table 161 and carries out a process according to the request from the host device 2 on the physical region (physical data region) specified by the physical address allocated to the logical address of the request.

The function of automatic layering of storage of the CM 3 may move data among the Tiers of a layered storage pool 6 depending on the access frequency to data and also on the response performance of the physical disks. If moving data using the function of automatic layering of storage, the CM 3 changes a physical volume 161c and a physical address 161d of the moved data in the logical volume 5 to ones after the moving in the allocation management table 161.

Each CM 3 includes a Channel Adapter (CA) 31, a Remote Adapter (RA) 32, the Central Processing Unit (CPU) 33, a memory 34, and multiple (two in FIG. 1) Disk Interfaces (DIs) 35.

The CA 31 is coupled to the host device 2 and is an adapter that controls interfacing of the CM 3 and the host device 2 and accomplishes data communication with the host device 2. The RA 32 is an adapter that is coupled to an RA 32 included in a CM 3 of another system 1 and that controls interfacing of the two systems 1, and accomplishes the data communication with the other system 1. The two DIs 35 control interfacing of the CM 3 and the respective two storage devices 4 included in the same system 1, and accomplishes data communication with the both storage devices 4.

The CPU 33 is coupled to the CA 31, the RA 32, the memory 34, and the DIs 35 and is a processor that carries out various controls and calculations. The CPU 33 functions through executing one or more programs stored in the physical disks in the layered storage pool 6 and/or a non-illustrated Read Only Memory (ROM).

The memory 34 is a memory device, such as a cache memory, that temporarily stores various pieces of data and programs. When the CPU 33 is to execute a program, the CPU 33 uses the program and data temporarily stored and expanded in the memory 34. For example, the memory 34 temporarily stores a program for causing the CPU 33 to function as a controller, data to be written from the host device 2 into the storage devices 4, and data to be read from the storage devices to the host device 2 or another CM 3. An example of the memory 34 is a volatile memory such as a Random Access Memory (RAM).

Here, each storage system 1 functions as a backup device 10 that generates a backup volume of a volume of a storage device 4 to be backed up, such as a work volume. For example, the storage system 1 may carry out backup in, for example, OPC, QOPC, or SnapOPC+ schemes, or backup through mirroring in EC and REC schemes.

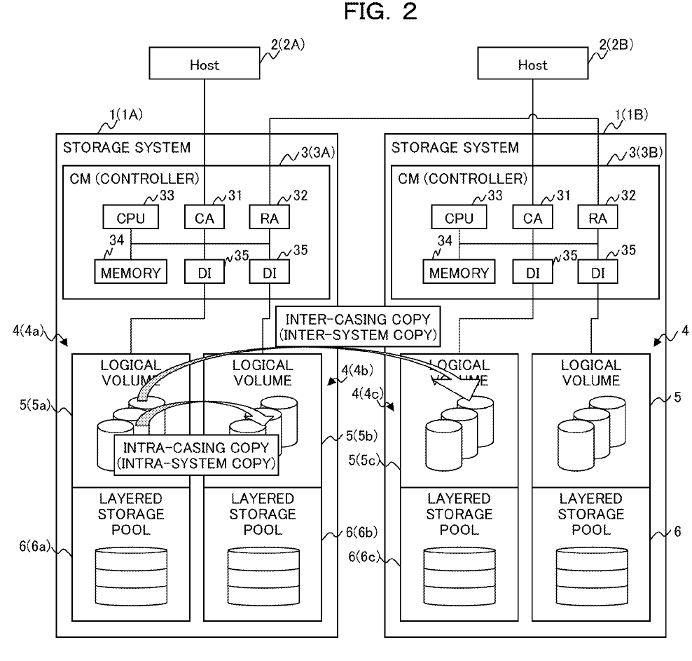

FIG. 2 is a diagram illustrating an example of a scheme of backup by the CM 3 serving as the backup device 10 and the storage devices 4a-4c of the first embodiment; and FIG. 3 is a diagram illustrating an example of a functional configuration of the backup device 10 of the first embodiment.

Hereinafter, description will now be made assuming that the storage system 1 (CM 3) of FIG. 1 generates a backup volume through copying data in the storage device 4a to be backed up into the storage device 4b or 4c, as illustrated in FIG. 2.

Specifically, the storage device 4a of the storage system 1A of the first embodiment stores a volume to be backed up, such as a work volume to be accessed by the host device 2. The storage system 1A (CM 3A) generates a backup volume containing data of the work volume through intra-copying the work volume (in the system) into the storage device 4b serving as a backup destination. The storage system 1 (CM 3A, CM 3B) generates a backup volume by inter-copying the data of the work volume into storage device 4c of the storage system 1B serving as the copy destination.

The work volume may be the entire logical data region of the logical volume 5a or may be part of the logical data region of the logical volume 5a. Similarly, the backup volume may be the entire logical data region of the logical volume 5b or 5c or may be part of the logical data region of the logical volume 5b or 5c. The logical data regions of the work volume and backup volume are each allocated to a physical data region of a physical volume in at least one layer of the corresponding layered storage pools 6a-6c.

Next, description will now be made in relation to the configuration of the backup device 10 of the first embodiment with reference to FIG. 3.

As illustrated in FIG. 3, the backup device includes the CM 3 serving as a controller that controls backup, the storage device 4a serving as a backup source (copy source), a storage device 4b or 4c serving as a backup destination (copy destination). When the storage device 4a and the storage device 4b serve as the copy source and the copy destination, respectively, the CM 3A functions as a controller whereas when the storage device 4a and the storage device 4c serve as the copy source and the copy destination, respectively, the CMs 3A and 3B cooperatively function as a controller.

(1-2) Description of a Backup Device:

Here, the backup device 10 of the first embodiment will now be briefly described.

As the above, in automatic layering of storage, collection and analysis of data on the performance of the layered storage pool 6b or 6c serving as the copy destination may result in rearrangement data of the backup volume into a subordinate (lower-speed) layer than the layer where the copy-source data is arranged in the work volume. Upon starting or restarting backup of the work volume serving as a copy source in the above rearrangement, the access speed to the backup volume is lower than that to the work volume, so that the backup processing speed is also low, which affects the performance of the entire system 1.

Further, even when the data of the backup volume is rearranged in a higher-speed layer by automatic layering in accordance with increase in the access frequency in the course of the backup, collection and analysis of the performance information hinder immediate response upon starting and resuming backup, which still affects the performance of the entire system 1.

Accordingly, the backup device 10 of the first embodiment carries out the following processes (i) and (ii) when copying the data of the work volume in the schemes of, for example, OPC, QOPC, SnapOPC+, EC, and REC.

(i) moving data at a copy destination that does not affect the system 1 (CM 3) serving as a copy source any longer to a lower-access-speed disk.

For example, upon receipt of an instruction of generating a backup volume, the process (i) copies the data of the work volume into a physical data region (first region) of the layered storage pool 6b or 6c of the copy destination. After the copying is completed, data of the backup volume stored in the first region is moved to a physical data region (second region) that is included in the layered storage pool 6b or 6c and that is a lower-speed (i.e., subordinate) physical data region than the first region.

(ii) releasing data of the backup volume when backup starts or restarts:

For example, upon receipt of an instruction of generating another backup volume under a state where the backup volume is stored in the second region, the process (ii) releases the data in the backup volume stored in the second region.

Upon completion of the backup through the process (i), the backup device 10 moves the data of the backup volume from the first region to the subordinate second region. Accordingly, the backup device 10 may move the data of the backup volume to a subordinate lower-access-speed layer (rearrangement) without collection and analysis of the performance information, so that the using efficiency of the first region of a higher-access-speed layer may be enhanced and the performance of the entire system 1 may be improved. Upon receipt of a new instruction of generating another backup volume, the backup device releases the data of the backup volume stored in the subordinate second region through the process (ii), which releases data in a physical data region (i.e., the second region) allocated to the backup volume. Accordingly, an instruction of another generation issued after the completion of the process (ii), since the backup volume is generated in the first region, which is superordinate of (higher than) the second region, through the process (i), may prevent the processing speed of backup from lowering and also prevent the performance of the storage system 1 from lowering.

Hereinafter, the above backup device 10 will now be detailed.

(1-3) Configuration of a Backup Device:

The CM 3 includes a generator 11, a mover 12, a releaser 13, a canceller 14, a layer controller 15, and a container 16 for the purpose of achieving the function of the backup device 10.

The generator 11 generates a backup volume by copying, upon receipt of an instruction of generating a backup volume from the host device 2, the data of a work volume to a first region of the storage device 4b or 4c.

Here, a first region is a physical data region of a predetermined physical volume in the layered storage pool 6b or 6c (first storage device). The first region is, for example, a physical data region of the layered storage pool 6b or 6c serving as the copy destination and is preferably a physical data region in a layer the same as or higher than the layer storing data of the copy source in the layered storage pool 6a (second storage device). The disk performance of the copy destination is preferably set to be equal to or higher than that of the copy source because the disk performance of the copy destination affects the system (CM 3) of the copy source during generating a backup volume (copying). Using the copy source poor in disk performance (e.g., low in access speed), the performance of the processing in the system 1 is not improved even if the disk having a high disk performance (e.g., high in access speed) is used. Accordingly, the first region is preferably a physical data region the same in layer as that of the physical data region in the layered storage pool 6a storing the data of the volume to be backed up.

The mover 12 moves the data of the backup volume stored in the first region to the second region that is a lower (subordinate) layer than that of the first region. Here, the second region is a physical data region in the layered storage pool 6b or 6c and is a region in a physical volume of a lower layer than that of the physical volume including the first region. In other words, the mover 12 moves data in a backup volume that does not affect the performance of the system 1 serving as a copy source to a low-access-speed layer. A backup volume that does not affect the performance of the system 1 serving as the copy source is a backup volume after the completion of copying in the OPC or QOPC scheme; a backup volume of one generation before in the SnapOPC+ scheme; and a backup volume after suspending of mirroring in the EC or REC scheme.

The releaser 13 releases data in a backup volume from the second region when receiving an instruction of generating a backup volume under a state where the data in the backup volume is stored in the second region.

When backup is started or restarted, the backup volume comes again to affect the system 1 of the copy source. For this reason, data of the backup volume moved to a low-access-speed disk is desired to be rearranged into the same layer as that of the data to be backed up. Here, rearrangement, which accompanies disk access, may itself affect the system 1 of the copy source. As a solution, the releaser 13 releases the physical region of the copy destination at the starting or restarting backup so that rearrangement is not needed. Releasing a physical region of a low-access-speed disk allocates, when backup is activated, a physical region of the same layer that the data to be backed up is stored to the data to be backed up. Consequently, the generator 11 may accomplish backup to a first region with minimum rearrangement.

The layer controller 15 collects and analyzes the performance information related to the volume to be backed up and controls moving (rearranging) a layer that is to store data of the volume to be backed up among the multiple layers, such as the Tier 0 to the Tier 2, of the layered storage pool 6a. Here, the layer controller 15 does not have to collect or analyze the performance information of the layered storage pools 6b and 6c to include the backup volume because the mover 12 controls moving of data among layers of the backup volume in the layered storage pool 6b and 6c, according to the backup schemes to be adopted such as OPC that are to be detailed below.

The generator 11, the mover 12, the releaser 13, and the canceller 14 are to be detailed below. In the first embodiment, the functions of the controller (i.e., the generator 11, the mover 12, the releaser 13, the canceller 14, and the layer controller 15) are achieved by the CPU 33. Alternatively, the function of the CM 3 may be achieved by an integrated circuit such as Application Specific Integrated Circuit (ASIC) IC) or Field Programmable Gate Array (FPGA) or by an electric circuit such as Micro Processing Unit (MPU).

The container 16 functions as a buffer that temporarily stores data of the copy source upon backup and also includes the allocation management table 161 and the updating management table 162. The container 16 is achieved by, for example, the memory 34.

(1-3-1) Description of the Allocation Management Table and the Updating Management Table:

The allocation management table 161 manages allocation of the physical data region of the layered storage pools 6 and the logical data regions of the logical volumes 5. In other words, the allocation management table 161 manages which physical address of the layered storage pools 6 is allocated to the certain logical address of a logical volume 5. For example, as illustrated in FIG. 4, the allocation management table 161 contains data which associates a logical address 161b of a logical volume 161a with a physical address 161d of a physical volume 161c in the layered storage pool 6.

A logical volume 161a is data, such as an identifier (ID), that identifies a logical volume 5; and a logical address 161b is a virtual address of a logical volume 5. An access request from the host device 2 is directed to a logical address 161b. A physical volume 161c is data, such as an ID, that identifies a physical disk (volume) in a layered storage pool 6; and a physical address 161d is an address of a physical volume 161c and is an address physically allocated to the logical address 161b.

Upon receipt of an instruction of generating a logical volume 5 from the host device 2, the CM 3 sets the ID of the generated logical volume 5 in the logical volume 161a of the allocation management table 161. The CM 3 sets a logical address 161b in units of predetermined sizes (e.g., in units of 0x10000 in FIG. 4) or sets the logical address 161b to be any desired size. Besides, the CM 3 allocates invalid value “0xFF . . . F” representing non-allocation in a physical volume 161c and physical address 161d associated with a logical address 161b such as the set logical address 161b, to which a physical disk has not been allocated yet.

As denoted in the example FIG. 4, a physical address 161d “0x11110000” (“0x11110000” through “0x1111FFFF”) of a physical volume 161c “0x0000” is allocated to a logical address 161b “0x10000” (“0x10000” through “0x1FFFF”) of a logical volume 161a “0x000A”. In the same manner, a physical address 161d “0x11120000” (“0x11120000” through “0x1112FFFF”) is allocated to a logical address 161b “0x20000” (“0x20000” through “0x2FFFF”). In contrast, since the logical address 161b “0x30000” (“0x30000” through “ . . . ”) of the logical volume 161a “0x000A” is not allocated a physical volume 161c, “0xFFFF” is set in the corresponding physical volume 161c and “0xFFFFFFFF” (“0xFFFFFFFF” through “0xFFFFFFFF”) is set in the corresponding physical address 161d.

Upon receipt of a request for a process on the logical volume 5 from the host device 2, the CM 3 carries out the requested process on the physical address 161d associated with the logical address 161b related to the request with reference to the allocation management table 161.

If no physical address 161d is allocated to the logical address 161b related to the request, the CM 3 dynamically allocates a region of the physical disk of the layered storage pool 6 to the logical address 161b related to the request and writes data into the region. Then, the CM 3 sets the ID of the region of the physical disk, in which region data is written to the physical volume 161c and also sets the writing address to the corresponding physical address 161d in the allocation management table 161. Still further, upon receipt of a request of, for example, volume formatting or initialization, from the host device 2, the CM 3 releases the data of the physical volume 161c or the physical address 161d allocated to the logical volume 161a or the logical address 161b that are related to the request, and sets invalid values in data related to the released physical region in the allocation management table 161.

The updating management table 162 divides the copying region of copy sessions in backup, that is, a logical data region of the work volume, in units of blocks of predetermined segments and records whether the individual blocks are updated by the host device 2. The updating management table 162 is generated for the entire logical volume 5a or for each part of the logical volume 5a.

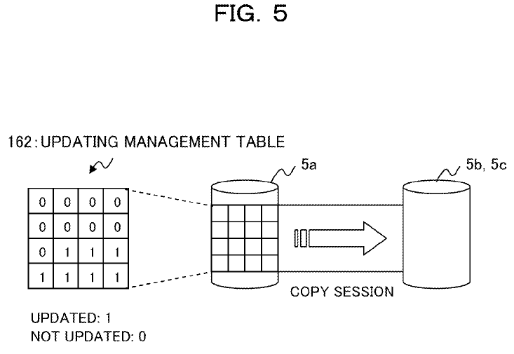

As illustrated in example FIG. 5, “1” is set in a block that is updated by the host device 2 while “0” is set in a block that is not updated by the host device 2 in the updating management table 162. In backup of a block of a work volume updated, the CM 3 refers to the updating management table 162 and determines a block set to “1” to a block to be copied. Upon updating a logical data region of the work volume, the CM 3 sets “1” in the block subjected to the updating in the updating management table 162. Conversely, upon backup of a block set to “1” in the updating management table 162, the CM 3 sets “0” in the block subjected to the backup.

(1-3-2) Example of a Configuration and an Operation of the Backup Device According to Backup Schemes:

Here, the backup device 10 carries out backup in response to an instruction of generating a backup volume from the host device 2. Examples of a backup scheme are OPC, QOPC, SnapOPC+, EC, and REC. The backup device 10 carries out backup in conformity with the scheme requested from the host device 2. Alternatively, the backup scheme to be carried out may be previously set in the backup device 10 (e.g., the container 16) and the backup device 10 may carry out backup in the predetermined scheme in response to an instruction of generating a backup volume from the host device 2.

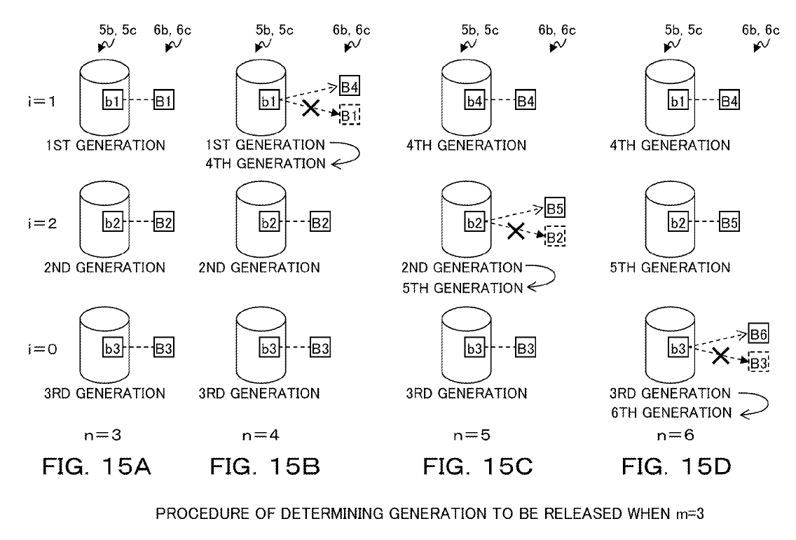

Hereinafter, description will now be made in relation to examples of the configuration and the operation of the backup device 10 in conformity with various backup schemes with reference to FIGS. 3, 6A-15D. FIGS. 6A through 14B illustrate examples of a procedure of generating a backup volume in the backup device 10 of the first embodiment; FIGS. 15A-15D illustrate an example of procedure of determining a generation to be released in SnapOPC+ by the releaser 13.

For simplification of description, description hereinafter assumes that the work volume to be backed up is the entire logical data region of the logical volume 5a and the backup volume is the entire logical data region of the logical volume 5b or 5c. Here, backup in the SnapOPC+ scheme, which generates backup volumes of multiple generations (e.g., m generations where m is a natural number of two or more), generates backup volumes of multiple m generations in the entire logical data region of the logical volume 5b or 5c.

In FIGS. 6A through 15D, regions a, a1, and a2 in the logical volume 5a are predetermined blocks of the logical data region of the work volume and are hereinafter referred to as logical blocks a, a1 and a2, respectively. Regions b, b1, and b2 in the logical volume 5b or 5c are predetermined blocks of the logical data region of the backup volume and are hereinafter referred to as logical blocks b, b1, and b2, respectively. Further, regions A, A1, A2, B, and B1 through B5 in the layered storage pools 6 are predetermined blocks of the logical data regions of the layered storage pools 6 and are hereinafter referred to as physical blocks A, A1, A2, B, and B1 through B5, respectively. The allocation management table 161 associates the physical blocks A, A1, A2, B, and B1 through B5 with the respective logical blocks connected via broken lines in the drawings.

For simplification of the description, the logical blocks and the physical blocks are assumed to correspond the logical data region and the physical data region, respectively, of the work volume and the backup volume. Actually, the logical data region and the physical data region of the work volume and the backup volume include multiple logical blocks and physical blocks.

(A) Operation Upon Receipt of an Instruction of Generating a Backup Volume in the OPC/QOPC Scheme:

First of all, description will now be made in relation to an example of the configuration and the operation of the backup device 10 upon receipt of an instruction of generating a backup volume in the OPC/QOPC scheme from the host device 2.

Upon receipt of an instruction (Start instruction) of generating a backup volume in the OPC or QOPC scheme, the generator 11 carries out copying of the entire work volume in the background. For example, as illustrated in FIG. 6A, the generator 11 allocates the physical block B1 in the Tier 0 to the logical block b of the backup volume and copies the data stored in the physical block A of the Tier 0, the data being allocated to the logical block a of the work volume, into the physical block B1 in the background. Referring to the allocation management table 161, the generator 11 determines a physical block, i.e., a physical volume (layer) or a physical address, to be allocated to each logical blocks of the backup volume.

After the generator 11 completes the copying, the mover 12 moves the data in the copy-destination physical blocks (first region) to the respective physical blocks (second region) in a lower layer (e.g., the lowest layer). This is based on the fact that: in the OPC or QOPC scheme, the backup volume does not affect the processing of the CM 3 on the work volume after the completion of background copying. For example, as illustrated in FIG. 6B, the mover 12 moves data in the physical block B1 on the Tier 0 to the physical block B2 of the Tier 2 lower than the Tier 0.

The mover 12 changes the physical address 161d of the physical block B1, which is allocated to the logical block b, to the physical address 161d of the physical block B2 in the allocation management table 161 concerning the backup volume. Hereinafter, the moving of data of the backup volume by the mover 12 includes updating of the allocation management table 161.

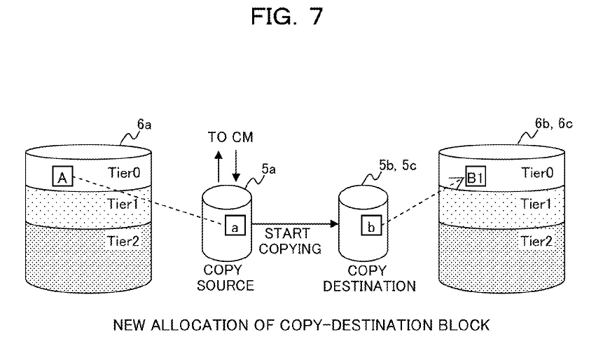

Here, the layer of each physical block (first region) of the layered storage pool 6b or 6c serving as the copy destination is preferably the same (or higher) tier of a physical block storing the data of the copy source. For example, as illustrated in FIG. 7, the generator 11 copies the data in the physical block A allocated to the logical block a into the physical block B1 that is in the same layer as that of the physical block A allocated to the logical block a. As the above, when a physical block of the backup volume is newly allocated, the generator 11 allocates a physical block in the same layer as that of the copy-source block.

Next, description will now be made in relation to the operation performed when an instruction of generating a backup volume in the OPC scheme for the second or subsequent time.

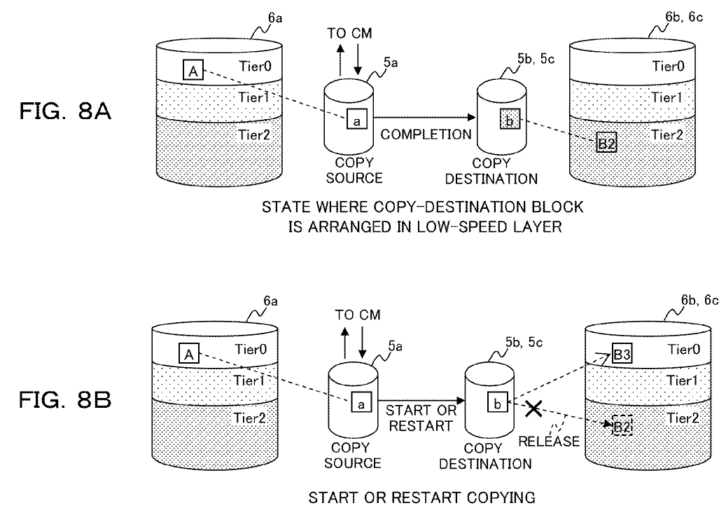

When the releaser 13 receives an instruction of generation in the OPC scheme for the second or subsequent time, in other words, when the releaser 13 receives instruction of starting or restarting backup, the releaser 13 releases data stored in the physical blocks in the Tier 2. Namely, the releaser 13 releases the physical region of the copy destination of the entire copying region when the releaser 13 receives an instruction of starting or restarting backup. For example, as illustrated in FIG. 8A, when an instruction of generating is received for the second or subsequent time, the data in the logical block b is stored in the physical block B2 in the Tier 2 that is low in access speed (see FIG. 6B). At that time, as illustrated in FIG. 8B, the releaser 13 releases the physical block B2 in the Tier 2 allocated to the logical block b.

Specifically, the releaser 13 sets the invalid value in the physical volume 161c and physical address 161d allocated to the logical block b in the allocation management table 161 and deletes the data in the physical block B2. Hereinafter, the releasing of a physical block (data in the backup volume) by the releaser 13 includes the above deleting of data in the physical block and updating of the allocation management table 161.

Since the releaser 13 releases the data of the backup volume stored in the physical blocks in the Tier 2, the generator 11 allocates physical blocks to respective logical blocks of the copy destination when the generator 11 receives an instruction of generation for the second or subsequent time, so that a new physical block is allocated as illustrated in FIG. 7 to carry out copying. For example, as illustrated in FIG. 8B, the generator 11 newly allocates a physical block B3 in the Tier 0 to the logical block b and then starts the copy.

Upon receipt of an instruction of generating a backup volume in the QOPC scheme for the second or subsequent time, the CM 3 backs up differential data from that subjected to the immediate-previous backup.

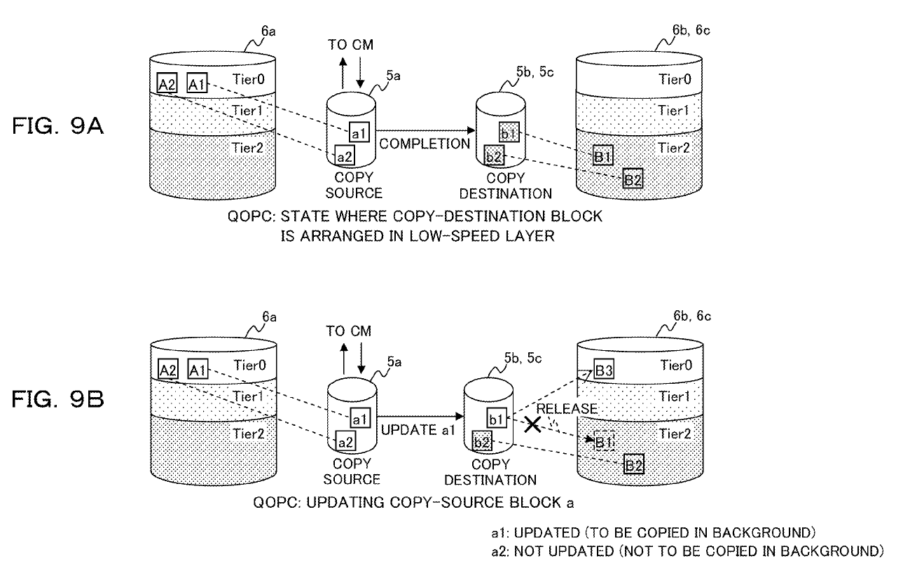

In the event of receipt of an instruction of generation in the QOPC scheme for the second or subsequent time, the releaser 13 releases data that is stored in physical blocks on the Tier 2 of the backup volume and that is corresponding to the data updated in the work volume for a time period from the receipt of the immediately previous instruction to the receipt of the current instruction. Physical blocks in the Tier 2 that store data corresponding data not updated are not released because the physical blocks do not affect the CM 3 of the copy destination. For example, as illustrated in FIG. 9A, when an instruction of generation for the second or subsequent time is received, the data in the logical blocks b1 and b2 are stored in the physical blocks B1 and B1 of the Tier 2 low in access speed (see FIG. 6B). At that time, referring to the updating management table 162, the releaser 13 determines that the data in the logical block a1 is updated but that the data in the logical block a2 is not updated. Then, as illustrated in FIG. 9B, the releaser 13 releases the data of the backup volume stored in the physical block B1 on the Tier 2 corresponding to the logical block a1 determined to be updated in the same manner as performed in the OPC scheme.

The generator 11 copies data updated in the work volume for a time period from the receipt of the immediately previous instruction to the receipt of the current instruction to a corresponding physical block so that the backup volume is generated (updated). For example, the generator 11 recognizes the updated logical block a1 with reference to the updating management table 162, and as illustrated in FIG. 9B, newly allocates the physical block B3 in the Tier 0 to the corresponding logical block b1 to carry out the copy.

(B) Operation Upon Receipt of an Instruction of Generating a Backup Volume in the SnapOPC+ Scheme:

Description will now be made in relation to an example of the configuration and the operation of the backup device 10 upon receipt of an instruction of generating a backup volume in the SnapOPC+ scheme from the host device 2.

Here, the generator 11, the mover 12, and the releaser 13 treat the allocation management table 161 in the same manner as performed in the OPC/QOPC scheme, so repetitious description is omitted here.

The SnapOPC+ scheme generates multiple pieces of backup data (backup volumes) of a single work volume in units of days and weeks. When the CM 3 accepts processing of the CM 3 on the work volume while SnapOPC+ i s being performed, since data before the updating is evacuated to the backup volume of the latest generation, the performance of the disk that stores the backup volume of the latest generation affects operation of the CM 3. Meanwhile, backup volumes except for the backup volume of the latest generation do not affect operation of the CM 3 on the work volume and may be stored in disks lower in access speed. For the above, upon switching the latest generation of a backup volume, the mover 12 moves the backup volume that comes to be not the latest generation any longer into a disk lower in access speed.

If the storage system 1 supports the CM 3 in generating a backup volume in the SnapOPC+ scheme, the storage device 4b or 4c of the copy destination stores backup volumes of multiple generations. Hereinafter, the storage device 4b or 4c is assumed to store backup volumes of the m generations, and the value m represents the maximum number of generations that the storage device 4b or 4c is capable of storing.

Hereinafter, description will now be made assuming that the backup device 10 receives an instruction (Start instruction) of generating a backup volume of the n-th generation (where, n is a natural number of two or more) in the SnapOPC+ scheme.

When the CM 3 receives an instruction of generating a backup volume of the n-th generation, the mover 12 moves data of the backup volume of one-generation before (i.e., the (n−1)-th generation) stored in the physical blocks (second region) of the layered storage pool 6b or 6c serving as the copy destination to physical blocks of a lower layer (e.g., the lowest layer).

When an instruction of generating a backup volume of the n-th generation is received, the generator 11 copies data that is data to be updated in the work volume during a time period from the reception of the current instruction to the reception of the next instruction of generating a backup volume of the next generation (i.e., the (n+1)-th generation) and that is data before the updating into predetermined physical block(s) of the layered storage pool 6b or 6c, so that the backup volume of the n-th generation is generated.

Specifically, upon receipt of the instruction of generating a backup volume of the n-th generation, the generator 11 monitors the work volume and thereby detects occurrence of updating of data in the work volume. In the event of detecting occurrence of updating, the generator 11 generates the backup volume of the n-th generation by copying data that is updated in the work volume but that is data before the updating into physical block(s) in the layered storage pool 6b or 6c. The generator 11 keeps the monitoring of the work volume and the generating of the backup volume of the n-th generation until the host device 2 instructs the generator 11 to stop the backup or to generate a backup volume of the next generation (i.e., (n+1)-th generation).

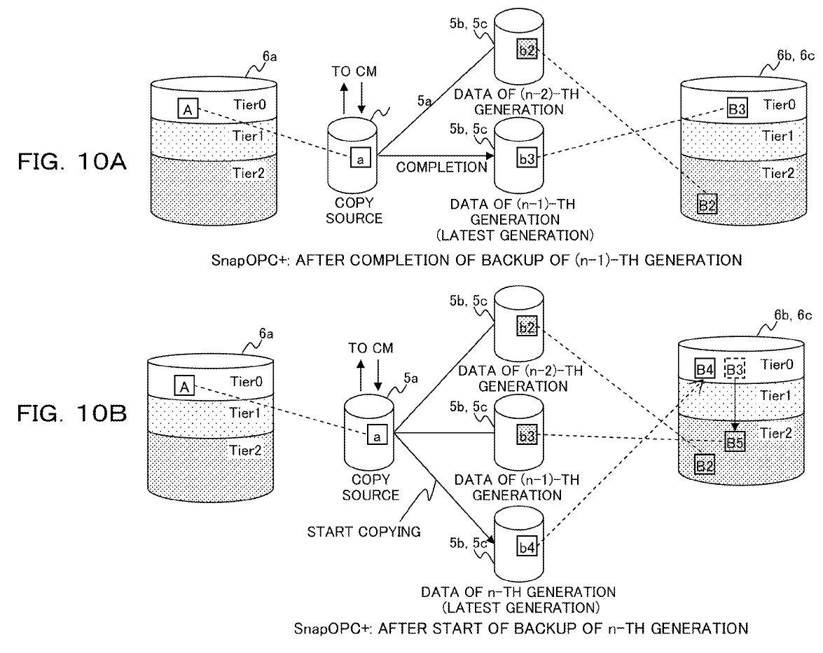

For example, as illustrated in FIG. 10A, upon completion of backup of the (n−1)-th generation, that is, upon receipt of an instruction of generating a backup volume of the n-th generation, data in logical blocks b2 and b3 related to the backup volumes of the (n−2)-th generation and the (n−1)-th generation, respectively, are being stored in the physical block B2 of the Tier 2 and the physical block B3 of the Tier 0, respectively. Upon receipt of an instruction of a backup volume of the n-th generation, the mover 12 moves the physical block B3 in the Tier 0 to a physical block B5 in a lower layer, the Tier 2, as illustrated in FIG. 10B. Furthermore, upon detection of updating in the work volume, the generator 11 allocates a physical block B4 in the Tier 0 to a logical block b4 related to the backup volume of the n-th generation and copies data in the work volume before the updating into the physical block B4.

In the same manner as the OPC or QOPC schemes, the copy-destination layer of the layered storage pool 6b or 6c (first region) is preferably the same as (or higher than) that of the physical block of the layered storage pool 6a storing the copy-source data (before the updating).

Here, as described above the storage device 4b or 4c is capable of storing backup volumes of m generations at the maximum. For example, under a state where backup volumes of m generations are already generated, upon receipt of generating a backup volume of the (m+1)-th generation from the host device 2, the CM 3 is desired to ensure an backup volume for exceeding one generation. As one solution, the CM 3 may overwrite the data related to the backup of the (m+1)-th generation onto one of the already-generated backup volumes except of the backup volume of the latest generation. However, data of the backup volumes except for the backup volume of the latest generation is stored in physical blocks in low-access-speed Tier 2 by the mover 12. Accordingly, backup of the (m+1)-th generation onto a backup volume except for that of the latest generation lowers the backup processing due to the difference in access speed between the work volume and the backup volume, so that the performance of the entire system declines.

For the above, if an instruction of generating a backup volume of the n-th generation is received when the relationship n>m is satisfied, the releaser 13 determines a backup volume to be released on the basis of the value n. Then the releaser 13 releases data of the backup volume stored in one or more physical blocks (region for the generation to be released, the second region) allocated to the determined generation to be released.

Hereinafter, the description assumes that the releaser 13 determines the oldest generation to be released.

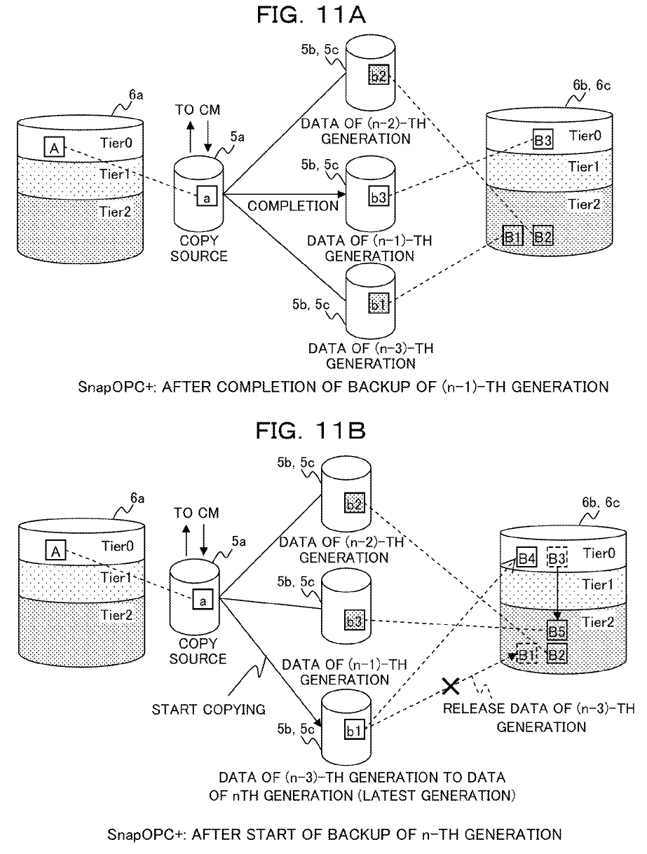

For example, as illustrated in FIG. 11A, description will now be made in relation to operation performed when m=3; the backup volume of the latest generation ((n−1)-th generation) is stored in the physical block B3 in the Tier 0; and data of the backup volumes of the (n−2)-th generation and the oldest (n−3)-th generation are respectively stored in the physical blocks B2 and B1 in the Tier 2.

If an instruction of generating the latest generation (i.e., the n-th generation) under the state of FIG. 11A, the releaser 13 releases the data (stored in the physical block B1) of the backup volume of the oldest (n−3)-th generation, as illustrated in FIG. 11B. In addition, the mover 12 moves the data of the backup volume of the one-generation before (the (n−1)-th generation), the data being stored in the physical block B3 in the Tier 0, to the physical block B5 of the Tier 2. After that, the generator 11 generates the backup volume of the n-th generation by allocating the physical block B4 in the Tier 0 to the logical block b1 the data of which is released from the physical block B1 in the Tier 2.

The CM 3 reserves one or more logical blocks in the logical volume 5b or 5c serving as a region (logical data region) for each of m generations that are the maximum storable generations. At that time, the CM 3 sets data (e.g., a value “i” from zero to m−1) to identify the reserved logical data regions for the respective generation and uses the set data to identify the respective backup volumes. When n>m is satisfied, the releaser 13 calculates the quotient obtained by dividing n by m to determine a generation to be released.

Hereinafter, description will now be made in relation to an example of determining a generation to be released by the releaser 13 when instructions of generating backup volumes of the 4th through 6th generations are received under the state of m=3 with reference to FIGS. 15A-15D. For simplifying the drawings, FIGS. 15A-15D omit illustration of the layered storage pool 6b or 6c, which however stores the physical blocks of the latest generation in the Tier 0 and the remaining physical blocks in the Tier 2. FIGS. 15A-15D assume that i=1 is set for the logical data region including a logical block b1; i=2 is set for the logical data region including a logical block b2; and i=0 is set for the logical data region including a logical block b3.

FIG. 15A represents a state of n=3, that is, the third generation is the latest. The physical blocks B1-B3 respectively allocated to the logical blocks b1-b3 store data of the backup volumes of the first to the third generations, respectively.

When an instruction of n=4, that is, generating a backup volume of the fourth generation is received, the releaser 13 calculates the quotient “1” by dividing 4, the value of n, by 3, the value of m. The releaser 13 determines a logical data region including the logical block b1, for which i=1 corresponding to the calculated quotient is set, to be the region of the generation to be released.

In the same manner, when an instruction of n=5, that is, generating a backup volume of the fifth generation is received, the releaser 13 calculates the quotient “2” by dividing 5, the value of n, by 3, the value of m. The releaser 13 determines a logical data region including the logical block b2, for which i=2 corresponding to the calculated quotient is set, to be the region of the generation to be released. As illustrated in FIG. 15C, the releaser 13 then releases a physical block B2 storing the backup volume of the oldest generation (second generation) allocated to the logical block b2.

Furthermore, when an instruction of n=6, that is, generating a backup volume of the sixth generation, the releaser 13 calculates the quotient “0” by dividing 6, the value of n, by 3, the value of m. The releaser 13 determines a logical data region including the logical block b3, for which i=0 corresponding to the calculated quotient is set, to be the region of the generation to be released. As illustrated in FIG. 15D, the releaser 13 then releases a physical block B3 storing the backup volume of the oldest generation (third generation) allocated to the logical block b3.

In FIGS. 15B-15C, the mover 12 moves the data of the backup volume of one-generation before, the data being stored in the Tier 0 into a predetermined physical block of the Tier 2. In addition, the generator 11 allocates another physical block to the logical block related to the physical block released by the releaser 13, and thereby generates a backup volume of the n-th generation.

(C) Operation Upon Receipt of an Instruction of Generating Backup Volume in the EC/REC Scheme:

Description will now be made in relation to an example of the configuration and the operation of the backup device 10 upon receipt of an instruction of generating a backup volume in the EC/REC scheme from the host device 2.

Here, the generator 11, the mover 12, and the releaser 13 treat the allocation management table 161 in the same manner as performed in the OPC/QOPC scheme, so repetitious description is omitted here.

The EC or REC scheme carries out mirroring of data between the work volume and a backup volume, and generates a snapshot through suspending the backup volume from the work volume at a certain time point. The suspended backup volume does not affect processing of the CM 3 on the work volume. Accordingly, at the time of the suspending, the mover 12 moves the data of the backup volume to a low-access-speed disk (layer).

The generator 11 includes a copier 11a and a suspender 11b for generating a backup volume in the EC/REC scheme.

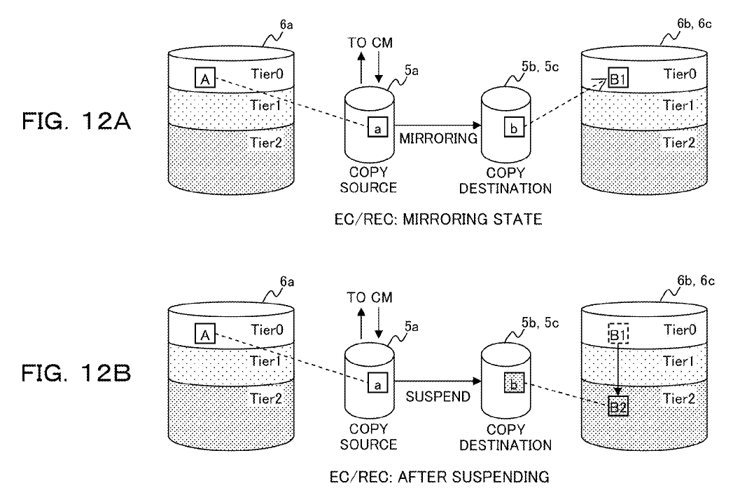

When an instruction of generating a backup volume in EC/REC scheme (Start instruction) is received, the copier 11a copies the data of the work volume to physical blocks (first region) of the layered storage pool 6b or 6c allocated to the backup volume. In other words, the copier 11a generates and keeps a mirroring (equivalent) state of the first region to the region of the layered storage pool 6a in which region the data of the work volume is stored. For example, as illustrated in FIG. 12A, the copier 11a allocates the physical block B1 in the Tier 0 to the logical block b of the backup volume and copies the data in the physical block A in the Tier 0, the block being allocated to the logical block a of the work volume, into a physical block B1 in the background.

The suspender 11b suspends the copier 11a from copying upon receipt of an instruction of suspending the equivalent state kept by the copier 11a (Suspending instruction).

Accordingly, the generator 11 generates a backup volume of the work volume having the contents at the time of receipt of a suspending instruction by the suspender 11b suspending the copier 11a from copying.

In the same manner as performed in the OPC/QOPC scheme, the mover 12 moves the data of the backup volume stored in the first region to a second region in a lower layer than that of the first region. For example, as illustrated in FIG. 12B, the mover 12 moves the data stored in the physical block B1 in the Tier 0 into a physical block B2 in the lower Tier 2.

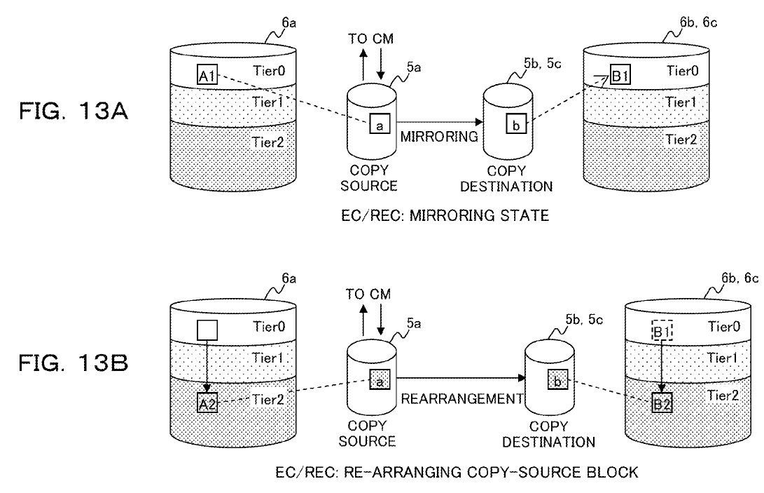

Here, the layer of each copy-destination physical block (first region) in the layered storage pool 6b or 6c is preferably the same as (or higher than) the layer of a physical block containing the copy-source data. For example, as illustrated in FIG. 13A, the generator 11 (copier 11a) copies data stored in the physical block A1 allocated to the logical block a into the physical block B1 in the same layer as that of the physical block A1.

Under the mirroring state kept by the copier 11a, the layer controller 15 of the CM 3 may move the data in the work volume stored in the copy-source layered storage pool 6a among the 0-th through the second layers depending of performance information such as an access frequency. In this case, the mover 12 moves the data copied into one or more physical blocks (first region) of the layered storage pool 6b or 6c by the copier 11a into one or more physical blocks (third region) of the layered storage pool 6b or 6c in a layer the same as or higher than the layer the physical block containing the data of the work volume in the layered storage pool 6a, the data being already moved.

For example, as illustrated in FIG. 13B, description will now be made assuming that, under the mirroring state kept by the copier 11a, the data of the logical block a is moved from the physical block A1 in the Tier 0 tier to the physical block A2 on the Tier 2. In this case, the mover 12 moves the data stored in the physical block B1 of the Tier 0 to the physical block B2 in the same layer as that of the physical block A2 on the Tier 2 in which the data of the work volume after the moving is stored.

In the EC/REC scheme, when the automatic layering of storage rearranges the data of the work volume in the copy-source storage device 4a, the layer of the copy-source comes to be different from that of the copy destination.

On the other hand, under the mirroring state in the EC/REC scheme, the layer of the copy-source is the same as that of the copy destination in the backup device 10, as described above. The backup device 10 makes the layer containing the data of a backup volume to correspond to that containing the data of the work volume. Accordingly, when the backup volume is working when a physical disk of the copy source fails or the copy-source storage device 4a is damaged by disaster, the performance of the storage system 1 may be maintained (that is, inhibited from degrading).

Upon receipt of an instruction of resuming the copying which is performed by the copier 11a but which is suspended by the suspender 11b (Resume instruction), the releaser 13 releases data which corresponds to the data updated in the work volume for a time period from the suspending by the suspender 11b to the receipt of the resume instruction from one or more physical blocks (second region) in the Tier 2 of the layered storage pool 6b or 6c.

Upon receipt of the resume instruction, the mover 12 moves the data not updated in the work volume for a time period from the suspending by the suspender 11b to the receipt of the resume instruction from one or more physical blocks (second region) in the Tier 2 of the layered storage pool 6b or 6c to one or more physical block (first region) in the same layered storage pool.

Namely, when a resume instruction in the EC/REC scheme is received, since only the data updated in the work volume during the suspending is to be copied by the copier 11a, the releaser 13 releases the copy-destination physical region corresponding to the updated data. The remaining non-updated data may affect the processing of the CM 3 on the work volume during mirroring. For the above, the mover 12 moves the data stored in the copy-destination region, the data being corresponding to the non-updated data, to a layer the same as or higher than the layer storing the data in the copy-source layered storage pool 6a (associating).

The canceller 14 included in the CM 3 cancels the suspending of the suspender 11b when the releaser 13 releases data of the backup volume.

When the canceller 14 cancels the suspending of the suspender 11b, the copier 11a copies data updated in the work volume for a time period from the suspending by the suspender 11b to the receipt of the resume instruction into one or more physical blocks (first region) of the layered storage pool 6b or 6c.

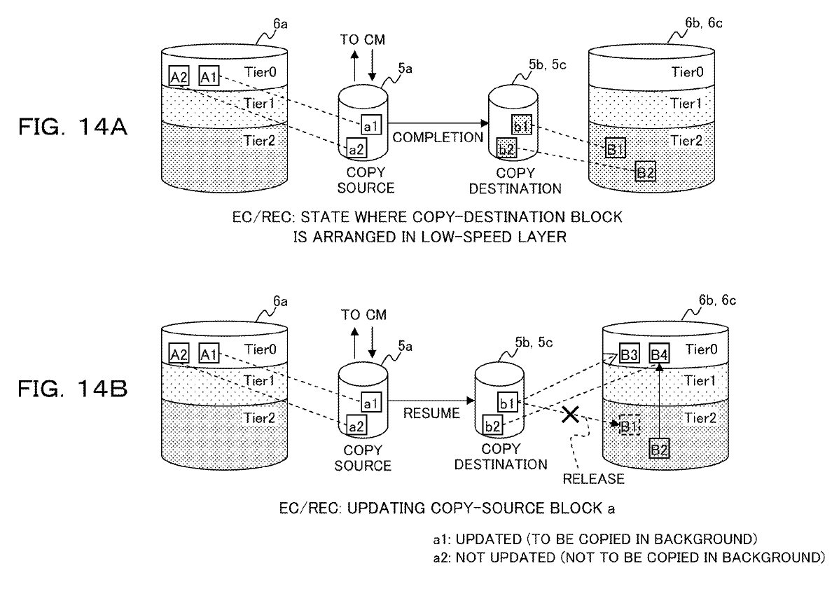

For example, as illustrated in FIG. 14A, data of the logical blocks b1 and b2 are respectively stored in the physical blocks B1 and B2 in the Tier 2 low in access speed when the resume instruction is received (see FIG. 12B). The CM 3 determines that the data of the logical block a1 is updated in the work volume for a time period from the suspending by the suspender 11b to the receipt of the resume instruction and that the data of the logical block a2 is not updated during the same time period with reference to the updating management table 162. As illustrated in FIG. 14B, the releaser 13 releases the data of the logical block b1, the data corresponding to the updated logical block a1 and being stored in the physical block B1 in the Tier 2 in the same manner as performed in the QOPC scheme.

As illustrated in FIG. 14B, the mover 12 moves the data of the logical block b2, the data corresponding to the non-updated logical block a2 and being stored in the physical block B2 in the Tier 2, to the physical block B4 on the Tier 0. Furthermore, the canceller 14 determines that the releaser 13 releases the data of the backup volume, and then cancels the suspending state by the suspender 11b. As illustrated in FIG. 14B, after the suspending state is cancelled, the copier 11a copies the data stored in the physical block A1 allocated to the updated logical block a1 to the physical block B3 in the Tier 0 newly allocated to the logical block b1.

(1-4) Example of Operation of the Backup Device:

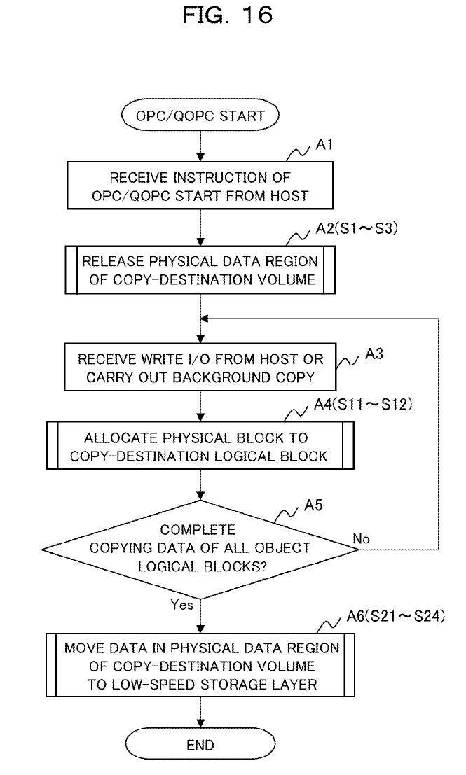

Next, description will now be made in relation to an example of operation of the backup device (storage system 1) of the first embodiment having the above configuration with reference to FIGS. 16-31. Here, FIGS. 16-31 are flow diagrams denoting examples of a succession of procedural steps of generating a backup volume by the backup device 10 of the first embodiment.

Hereinafter, description will now be made in relation to the respective backup schemes.

(1-4-1) Operation Upon Receipt of Generating a Backup Volume in the OPC Scheme:

Firstly, description will now be made in relation to an example operation of the backup device 10 to generate a backup volume in the OPC scheme with reference to FIGS. 16-19.

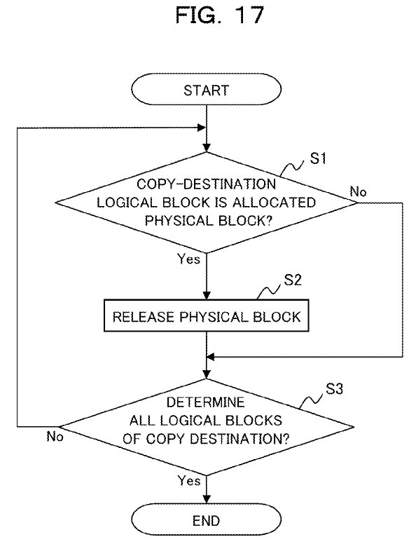

As illustrated in FIG. 16, when the backup device 10 receives an instruction of starting OPC (Start Instruction), that is, receives an instruction of generating a backup volume (step A1), the releaser 13 releases the copy-destination volume that is the physical data region of the backup volume (step A2, steps S1-S3 of FIG. 17; FIGS. 8A and 8B).

Specifically, as illustrated in FIG. 17, the releaser 13 refers to the allocation management table 161 and determines whether the copy-destination logical block is allocated a physical block (step S1). If the copy-destination logical block is allocated a physical block (Yes route in step S1), the releaser 13 releases the physical block allocated to the logical block (step S2) and then the procedure moves to step S3. In other words, the releaser 13 deletes the data of the physical block allocated to the logical block and sets invalid values in the physical volume 161c and physical address 161d associated with the logical block in the allocation management table 161, so that the physical block is released. Conversely, if the copy-destination logical block is not allocated a physical block (No route in step S1), the procedure skips step S2 and moves to step S3.

In step S3, the releaser 13 determines whether all the copy-destination logical blocks are each determined whether the logical block is allocated a physical block. If not all the copy-destination logical blocks undergo the determination of step S1 yet (No route in step S3), the procedure moves to step S1 to determine whether the next copy-destination logical block is allocated a physical block. If all the copy-destination logical blocks undergo the determination of step S1 (Yes route in step S3), releasing the physical data region of the backup volume by the releaser 13 (step A2 in FIG. 16) is terminated.

Referring back to FIG. 16, upon completion of step A2, the generator 11 copies data to be copied (of the copy source), that is data in the entire work volume, into one or more logical blocks corresponding to the physical data region released by the releaser in the background (see step A3, see FIGS. 8A and 8B). Here, if the host device 2 issues a request to, for example, write data into a copy-source logical block not copied yet, the generator 11 copies the data in the copy-source logical block related to the request preferentially over the background copy in step A3. Besides, if the host device 2 requests updating or reference of an instruction of writing data into a copy-destination logical block not copied yet, the generator 11 copies the data into the copy-destination logical block related to the request preferentially over the background copy.

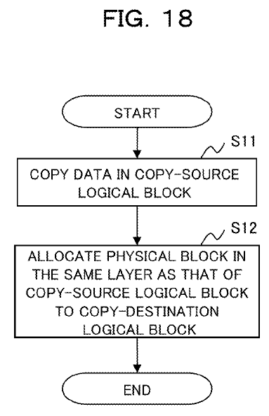

Here, in the copying by the generator 11 of step A3, a physical block is allocated to the copy-destination logical block as step A4 (corresponding to step S11 and S12 of FIG. 18) (see FIG. 7). Specifically, as illustrated in FIG. 18, upon copying data into the copy-source logical block (step S11), the generator 11 allocates a physical block same in a layer as the physical layer of the copy-source logical layer to a physical layer of the copy-destination logical layer (step S12).

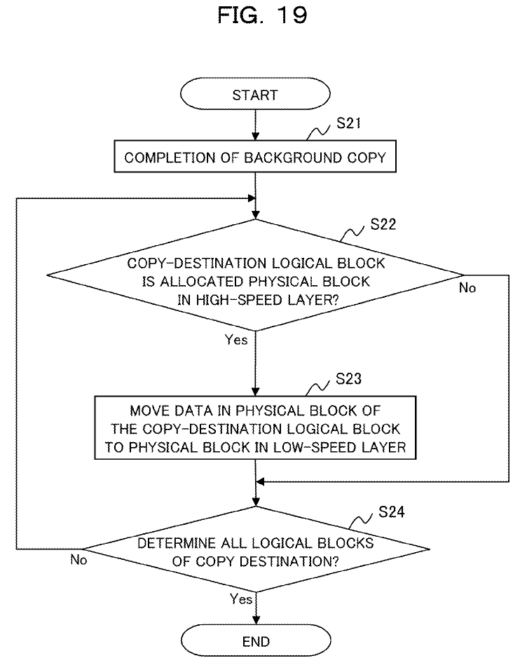

Referring back to FIG. 16, upon completion of step A4, the generator 11 determines whether data of all the copy-source logical blocks are copied (step A5). If the data of not all the copy-source logical blocks are copied (No route in step A5), the procedure moves to step A3 to copy data of the next copy-source logical block. In contrast, if the data of all the copy-source logical blocks is copied (Yes route in step A5), the mover 12 moves data in the physical data region of the backup volume to a low-access-speed layer (step A6, steps S21-S24 of FIG. 19, and see FIGS. 6A and 6B).

Specifically, as illustrated in FIG. 19, upon completion of background copy by the generator 11 (step S21), the mover 12 determines whether a copy-destination logical block is allocated a physical block in a high-access-speed layer (step S22). If a physical block in a high-access-speed layer is allocated to the logical block (Yes route in step S22), the mover 12 moves the data in the physical block allocated to the copy-destination logical block to a physical block in a low-access-speed layer (step S23) and then the procedure moves to step S24. Namely, the mover 12 moves the data in the allocated physical block into a physical block in a lower-speed physical volume and also sets data of the physical block after the data moving of step S23 in the physical volume 161c and the physical address 161d related to the copy-destination logical block in the allocation management table 161. In contrast, if a physical block in a high-access-speed layer is not allocated to the logical block (No route in step S22), the procedure skips step S23 and directly moves to step S24.

In step S24, the mover 12 determines whether all the copy-destination logical blocks are each determined whether the logical blocks are allocated to respective physical blocks in high-access-speed layer. If not all the copy-destination logical blocks undergo the determination (No route in step S24), the procedure moves step S22 to determine whether the next copy-destination is allocated a physical block in a high-access-speed layer. In contrast, if all the copy-destination logical blocks undergo the determination (Yes route in step S24), the procedure to move the physical data region of the backup volume by the mover 12 (step A6 in FIG. 16) is completed, so that the procedure of generating a backup volume in the OPC scheme is completed.

Since the OPC scheme copies the entire work volume each time the backup volume, the backup device 10 carries out the above procedures of FIGS. 16-19 each time the backup device 10 receives an instruction of generating a backup volume from the host device 2.

(1-4-2) Operation Upon Receipt of an Instruction of Generating a Backup Volume in the QOPC Scheme:

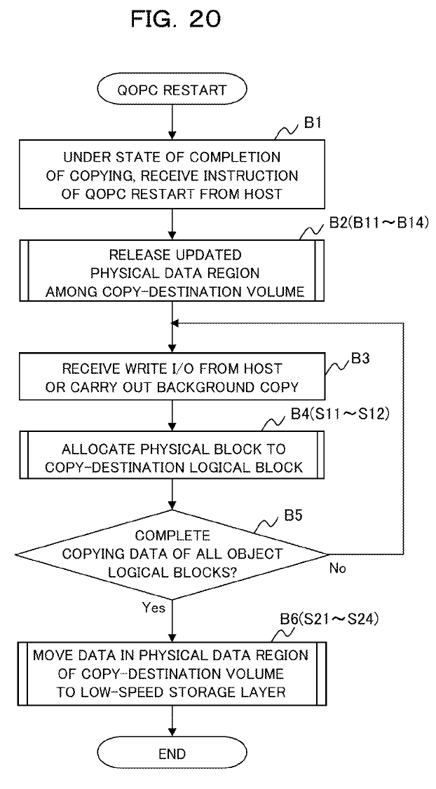

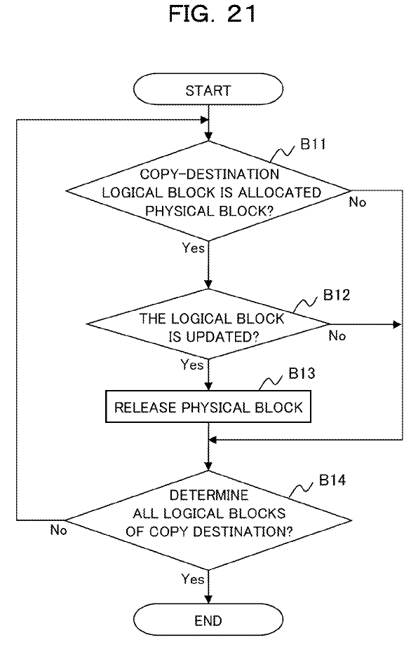

Next, description will now be made in relation to an example of procedure of generating a backup volume in the QOPC scheme with reference to FIGS. 20 and 21.

The QOPC scheme generates a backup volume for the first time in the same manner as the above OPC scheme (see FIGS. 16-19).

Hereinafter, the procedure carried out when the backup device 10 receives an instruction of generating a backup volume for the second and subsequent times (Restart instruction) will now be described.

First of all, when the backup device 10 receives an instruction of restarting the QOPC scheme from the host device 2 after the previous generation of a backup volume in the QOPC scheme is completed (step B1), the releaser 13 carries out the following procedure. Specifically, the releaser 13 releases a physical data region of the copy-destination volume, the physical data region corresponding to data updated in the work volume (step B2, Steps B11-B14 of FIG. 21, see FIGS. 9A and 9B) after the reception of the immediately-previous instruction of generating a backup volume in the QOPC scheme.

Specifically, as illustrated in FIG. 21, the releaser 13 refers to the allocation management table 161 to determine a copy-destination logical block is allocated a physical block (step B11). If the copy-destination logical block is allocated a physical block (Yes route in step B11), the releaser 13 refers to the updating management table 162 to determine whether the logical block in question is updated from the receipt of the immediately-previous instruction (step B12). If the logical block is updated (Yes route in step B12), the releaser 13 releases the physical block allocated to the logical block in question (step B13; step S2 in FIG. 17) and the procedure moves to step B14.

If the copy-destination logical block is not allocated a physical block in step B11 (No route in step B11) or if the logical block is not updated in step B12 (No route in step B12), the procedure skips step B13 and moves to step B14. In step B14, the releaser 13 determines whether all the copy-destination logical blocks are determined whether the logical blocks are allocated respective physical blocks. If not all the logical blocks undergo the determination (No route in step B14), the procedure moves to step B11 to determine whether the next copy-destination logical block is allocated a physical block. If all the copy-destination logical blocks undergo the determination (Yes route in step B14), the release of the physical data region of the backup volume by the releaser 13 (step B2 of FIG. 20) is completed.

Referring back to FIG. 20, upon completion of step B2, the generator 11 copies data of one or more logical blocks corresponding to one or more logical blocks to be copied (copy-source logical blocks), that is, data updated in the work volume, into the backup volume in steps B3-B5 (see FIGS. 9A and 9B). In step B6, the mover 12 moves data in the physical data region of the backup volume, that is, data in the physical blocks corresponding to the updated data, to a physical data region in a low-access-speed layer (see FIGS. 6A and 6B), and thereby generation of a backup volume in the QOPC scheme is completed. The procedure of steps B3-B6 is substantially identical to that of steps A3-A6 in FIG. 16 except for the point that the logical blocks to be copied (i.e., copy-source logical blocks) are changed from “the entire work volume” to “one or more logical blocks corresponding to data updated in the work volume”, so detailed description thereof is omitted here.

(1-4-3) Operation Upon Receipt of an Instruction of Generating a Backup Volume in the SnapOPC+:

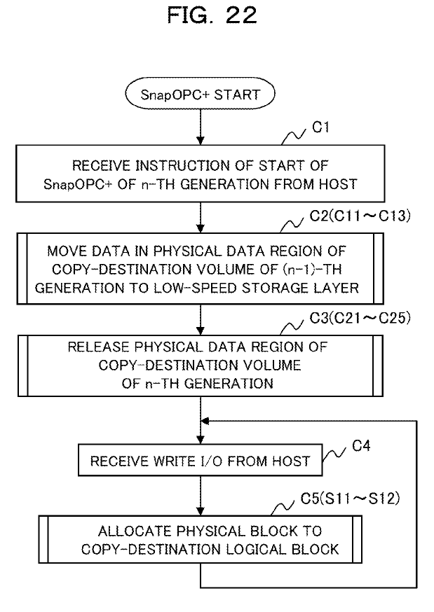

Next, description will now be made in relation to operation of generating a backup volume in the SnapOPC+ scheme by the backup device 10 with reference to FIGS. 22-24.

The following description assumes that the backup device 10 receives an instruction of generating a backup volume in a particular generation (e.g., the n-th generation) in the SnapOPC+ scheme.

To begin with, as illustrated in FIG. 22, when the backup device 10 receives an instruction of starting the n-th generation, that is, instruction of generating a backup of the n-th generation, in the SnapOPC+ scheme from the host device 2 (step C1), the mover 12 carries out the following procedure.

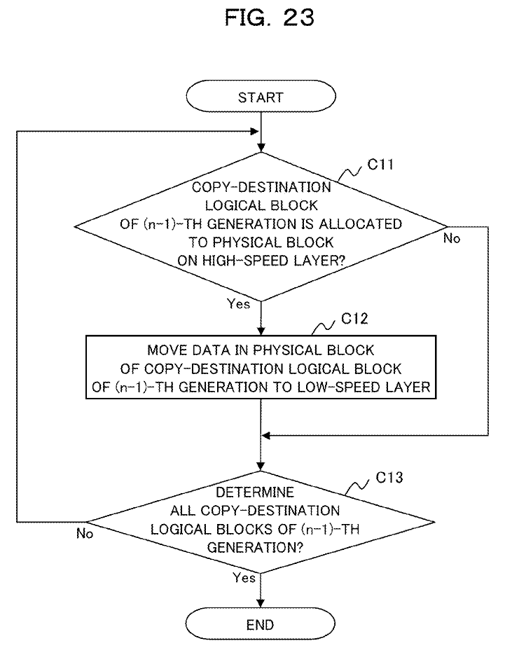

Specifically, the mover 12 moves the data in the physical data region of the backup volume of one-generation before, i.e., the (n−1)-th generation, to a low-access-speed layer (step C2, steps C11-C13 of FIG. 23, and see FIGS. 10A and 10B).

Specifically, as illustrated in FIG. 23, the mover 12 determines whether a copy-destination logical block of the (n−1)-th generation is allocated to a physical block in a high-access-speed layer (step C11). If the copy-destination logical block is allocated to a physical block in a high-access-speed layer (Yes route in step C11), the mover 12 moves the data in the physical block allocated to the copy-destination logical block of the (n−1)-th generation to a physical block in a low-access-speed layer (step C12, see step S23 in FIG. 19), and the procedure then moves to step C13. On the other hand, if the copy-destination logical block is not allocated to a physical block in a high-access-speed layer (No route in step C11), the procedure skips step C12 and directly moves to step C13.

In step C13, the mover 12 determines whether all the copy-destination logical blocks of the (n−1)-th generation are determined whether the respective logical blocks are allocated to physical blocks in a high-access-speed layer. If not all the copy-destination logical blocks undergo the determination (No route in step C13), the procedure moves to step C11 to determine whether the next copy-destination logical block of the (n−1)-th generation is allocated to a physical block in a high-speed layer. In contrast, if all the copy-destination logical blocks undergo the determination (Yes route in step C13), the moving (step C2 in FIG. 22) of the physical data region of the backup volume of the previous generation ((n−1)-th generation) by the mover 12 is completed.

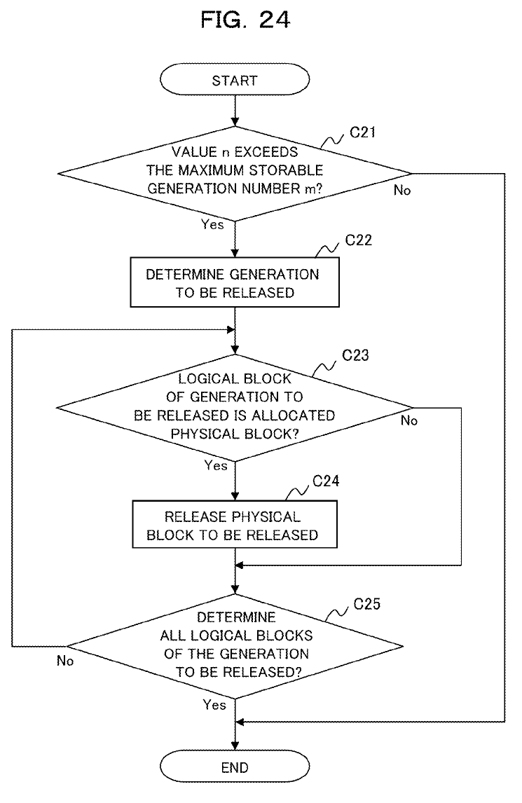

Referring back to FIG. 22, upon completion of step C2, the releaser 13 releases the physical data region of the backup volume of the n-th generation (step C3, steps C21-25 in FIG. 24, see FIGS. 11A and 11B).

Specifically, as illustrated in FIG. 24, the releaser 13 determines whether the value n exceeds the maximum storable generation number m (step C21). If the value n exceeds the number m (Yes route in step C21), the releaser 13 determines a generation the backup volume of which is to be released (the generation to be released) (step C22). For example, the releaser 13 determines the oldest generation to be released on the basis of the value n (see FIGS. 15A-15D).

Next, the releaser 13 refers to the allocation management table 161 to determine whether a logical block of the generation to be released is allocated a physical block (step C23). If the logical block is allocated a physical block (Yes route in step C23), the releaser 13 releases the physical block allocated to the logical block of the generation to be released (step C24, see step S2 in FIG. 17), and the procedure then moves to step C25. Conversely, the logical block is not allocated a physical block (No route in step C23), the procedure skips step C24 and directly moves to step C25.

In step C25, the releaser 13 determines whether all the logical blocks of the generation to be released are determined whether the logical blocks are allocated respective physical blocks. If not all the logical blocks of the generation to be released undergo the determination (No route in step C25), the procedure moves to step C23 to determine whether the next logical block of the generation to be released is allocated a physical block. In contrast, if all the logical blocks of the generation to be released undergo the determination (Yes route in step C25), or if the value n does not exceed the number m (No route in step C21), the release of the physical data region of the backup volume of the n-th generation (step C3 in FIG. 22) is completed.

Referring back to FIG. 22, upon completion of step C3, the generator 11 starts copying (step C4, see FIGS. 11A and 11B) in the event of receipt of a command such as a write I/O from the host device 2. Specifically, the generator 11 copies copy-source data in the work volume before updating the data to be updated in response to the request, such as the write I/O, to the copy-destination logical block the physical data region of which is released by the releaser 13. After the data in the logical block related to the data before the updating is copied to the backup volume by the generator 11, the CM 3 updates data in the logical block in response to the request, such as a write I/O.

Here, in the copying by the generator 11 in step C4, upon completion of copying data of a copy-source logical block in step C5 (steps S11 and S12 of FIG. 18) (step S11), the generator 11 allocates the physical block of the copy-destination logical block from a physical block in the layer the same as that of the physical block of the corresponding copy-source logical block (step S12).

The SnapOPC+ carries out the procedure of steps C4 and C5 until the backup device 10 receives an instruction of generating a backup volume of the next generation (i.e., (n+1)-th generation).

(1-4-4) Operation Upon Receipt of an Instruction of Generating a Backup Volume in the EC/REC Scheme:

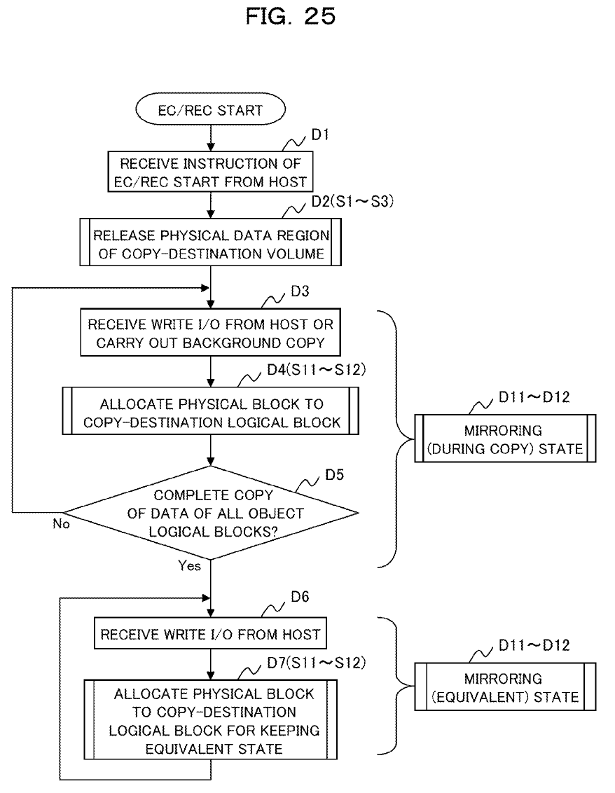

Next, description will now be made in relation to operation of generation a backup volume in the EC or REC scheme by the backup device 10 with reference to FIGS. 25-31.

First of all, as illustrated in FIG. 25, when the backup device 10 receives an instruction of starting the EC or REC scheme (Start instruction) from the host device 2 (step D1), the releaser 13 releases the copy-destination volume, that is, the physical data region of the backup volume (step D2, steps S1-S3 of FIG. 17). Namely, as described above with reference to steps S1-S3 in FIG. 17, if a physical block is allocated to each copy-destination logical block, the physical block allocated to the logical blocks are released by the releaser 13.

Referring back to FIG. 25, upon completion of step D2, the copier 11a copies the data to be copied (copy-source data), that is, the data of the entire work volume, to the respective copy-destination logical blocks the physical data regions of which are released by the releaser 13 in the background (step D3). If the host device 2 issues a request, such as a write I/O, on a copy-source logical block the data in which is not copied yet in step D3, the copier 11a copies the data of the logical block related to the request to a copy-destination logical block preferentially over the background copying. If the host device 2 issues a request for updating or reference, such as a write I/O, on a copy-destination logical block into which data is not copied yet, the generator 11 copies data into the copy-destination logical block related to the request preferentially over the background copying.

Here, in the copying by the copier 11a in step D3, a physical block is allocated to a copy-destination logical block in step D4 (steps S11 and S12 in FIG. 18) (see FIG. 13A). Specifically, as illustrated in FIG. 18, upon completion of copying data of the copy-source logical block (step S11), the generator 11 allocates a logical block of the copy-destination logical block from a physical block in the layer the same as that of the physical block of the corresponding copy-source logical block (step S12).

Referring back to FIG. 25, upon completion of step D4, the copier 11a determines whether copying of the data of all the logical blocks to be copied is completed (step D5). If the copying is not completed yet (No route in step D5), the procedure moves to step D3 to copy the data in the next logical block to be copied. The state in steps D3-D5 is referred to as a state of copying in mirroring (mirroring (during copying) state).

In contrast, if copying the data of all the logical blocks to be copied is completed (Yes route in step D5), the state of copying in mirroring, that is, background copying of the entire work volume in response to Start instruction in the EC/REC scheme, is completed and the procedure moves to step D6. When the host device 2 issues a request, such as a write I/O, on a copy-source logical block in step D6, the copier 11a copies the data in the copy-source logical block to be updated in response to the request from the host device 2 into a corresponding copy-destination logical block.

Here, during the copying by the copier 11a in step D6, the copier 11a keeps the equivalent state of the data and the layer of the physical data region of the work volume to those of the physical data region of the backup volume (step D7). In other words, the copier 11a allocates the physical block to each copy-destination logical block in the manner described above with reference to steps S11 and S12 of FIG. 18. The state of steps D6 and D7 is referred to as the equivalent state of mirroring (i.e., mirroring (equivalent) state).

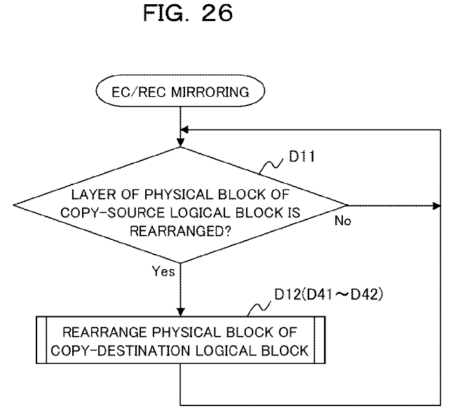

In the mirroring (during copying) state and the mirroring (equivalent) state, the procedure of steps D11-D12 of FIG. 26 is carried out in parallel with the procedure of steps D3-D5 or the procedure of steps D6-D7 (see FIG. 13B). Namely, as illustrated in FIG. 26, the mover 12 determines whether rearrangement for the layer of the physical block of a copy-source logical block is made (step D11). If the layer is rearranged (Yes route in step D11), the procedure moves to the next step D12 whereas if the layer is not rearranged (No route in step D11), the procedure skips step D12 and moves back to step D11.

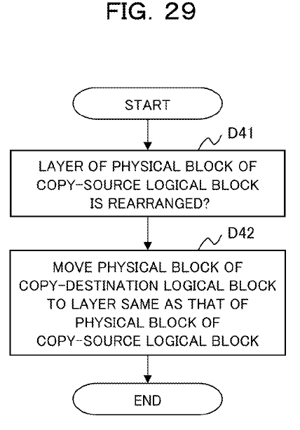

In step D12, the mover 12 rearranges the physical block of the copy-source logical block (steps D41 and D42 in FIG. 29), and the procedure then moves to step D11.

Specifically, as illustrated in FIG. 29, after the layer controller 15 rearranges the layer of the physical block of a copy-source logical block (step D41), the mover 12 moves the physical block of a copy-destination logical block to a layer the same as that of the physical block of the corresponding copy-source logical block (step D42).

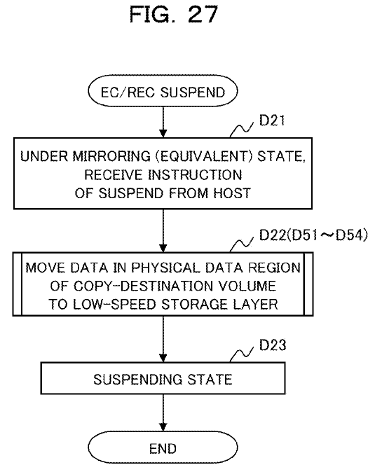

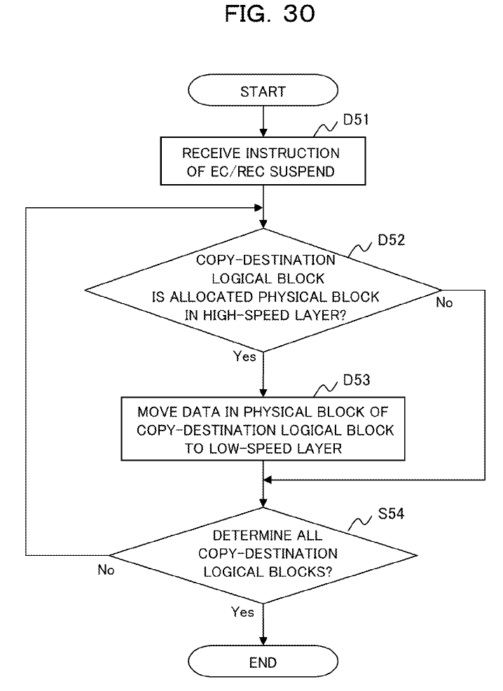

As illustrated in FIG. 27, when a suspending instruction is received from the host device 2 under the above mirroring (equivalent) state (step D21), the suspender 11b suspends the mirroring of the copier 11a and generates a backup volume at the time of the reception of the suspend instruction. Then the mover 12 moves the data in the physical data region of the copy-destination volume to a low-access-speed layer (step D22, steps D51-D54 of FIG. 30, see FIGS. 12A and 12B).

Specifically, as illustrated in FIG. 30, when an instruction (Suspending instruction) of suspending the mirroring in the EC/REC scheme from the host device 2 is received, the suspender 11b suspends the copier 11a from copying (step D51). Then, the mover 12 determines whether allocation for a physical block of a high-access-speed layer to a copy-destination logical block is made (step D52). If the copy-destination logical block is allocated a physical block in a high-access-speed layer (Yes route in step D52), the mover 12 moves the data in the physical block allocated to the copy-destination logical block to a physical block in a low-access-speed layer (step S53, see step S23 in FIG. 19) and the procedure then moves to step D54. In contrast, if the copy-destination logical block is not allocated a physical block in a high-access-speed layer (No route in step D52), the procedure skips step D53 and directly moves to step D54.

In step D54, the mover 12 determines whether all the copy-destination logical blocks are determined whether the logical blocks are allocated respective physical blocks in a high-access-speed layer. If not all the copy-destination logical blocks undergo the determination (No route in step S54), the procedure moves to step D52 to determine whether the next copy-destination logical block is allocated a physical block in a high-access-speed layer. In contrast, all the copy-destination logical blocks undergo the determination (Yes route in step D54), the moving of the physical data region of the backup volume by the mover 12 (step D22 of FIG. 27) is completed.

Referring back to FIG. 27, upon completion of step D22, the EC/REC scheme comes into a suspending state (step D23).

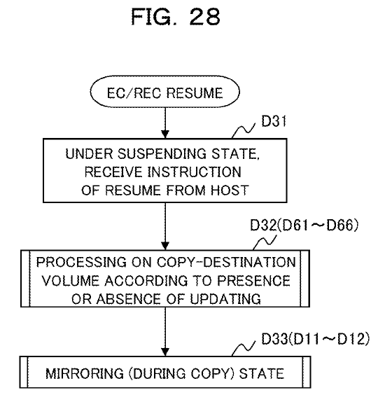

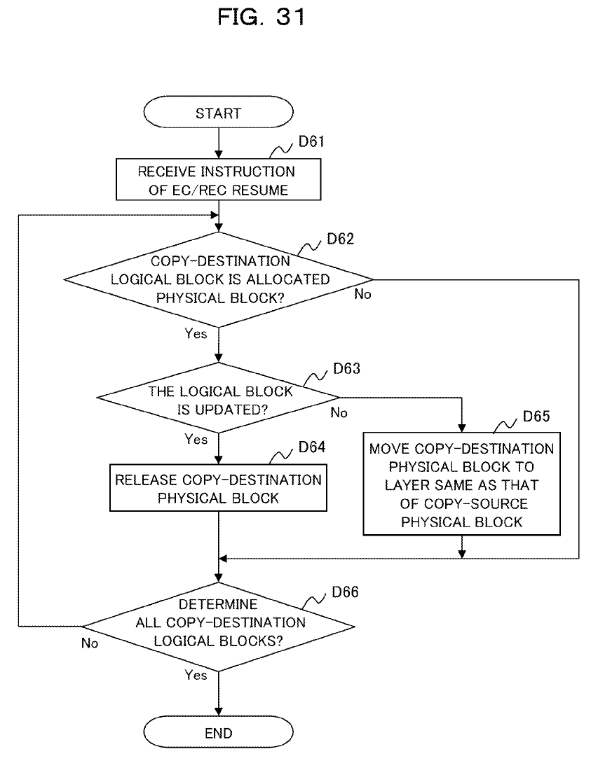

As illustrated in FIG. 28, when an instruction (Resume instruction) of resuming the EC/REC scheme from the host device 2 under the suspending state (step D31), the backup volume is to be processed according to the presence or the absence of data updating (step D32, steps D61-D66 in FIG. 31, see FIGS. 14A and 14B).

Specifically, as illustrated in FIG. 31, upon receipt of a Restart instruction (Resume instruction) of mirroring in the EC/REC scheme from the host device (step D61), the CM 3 refers to the allocation management table 161 to determine whether a copy-destination logical block is allocated a physical block (step D62). If the copy-destination logical block is allocated a physical block (Yes route in step D62), the CM 3 further refers to the updating management table 162 to determine whether the data of the logical block is updated in the work volume for a time period from the suspending by the suspender 11b to the receipt of the Resume instruction (step D63). If the data is updated (Yes route in step D63, the releaser 13 releases the physical block allocated to the logical block in question (step D64, see step S2 in FIG. 17) and the procedure moves to step D66.

In contrast, if the data of the logical block in question is not updated in the work volume for a time period from the suspending by the suspender 11b to the receipt of the Resume instruction (No route in step D63), the mover 12 moves the data of the physical block allocated to the logical block to a layer the same as that of the physical block of the corresponding copy-source logical block (step D65) and the procedure moves to step D66. Namely, the mover 12 sets information related to the physical block after the moving in the physical volume 161c and the physical address 161d corresponding to the copy-destination logical block in question in the allocation management table 161.

If the copy-destination logical block is not allocated a physical block (No route in step D62), the procedure skips steps D64 and D65 and directly moves to step D66. In step D66, the CM 3 determines whether all the copy-destination logical blocks are determined whether the logical blocks are allocated respective physical blocks. If not all the copy-destination logical blocks undergo the determination (No route in step D66), the procedure moves to step D62 to determine whether the next copy-destination logical block is allocated a physical block. In contrast, if all the copy-destination logical blocks undergo the determination (Yes route in step D66), the CM 3 terminates the procedure according to the presence or the absence of data updating (step D32 in FIG. 28).

Referring back to FIG. 28, upon completion of step D32, the canceller 14 cancels the state of suspending the copying by the copier 11a, so that the EC/REC scheme comes into the mirroring (during copy) state (step D33, and steps D11 and D12 of FIG. 26). In detail, the copier 11a copies the data updated in the work volume for a time period from the suspending by the suspender 11b to the receipt of the Resume instruction into the physical blocks allocated to the copy-destination logical blocks (step D3-D5 in FIG. 25).

For the above, the EC/REC scheme moved from the mirroring (during copy) state to the mirroring (equivalent) state in response to an instruction (Start instruction) of generating a backup volume, and upon receipt of a Suspending instruction during the mirroring state, moves into the suspending state. Upon receipt of a Resume instruction under the suspending state, the EC/REC scheme moves into the mirroring state again, so that the procedures described above with reference to FIGS. 25-31 are carried out.

(1-5) Result:

As described above, when the backup device 10 of the first embodiment receives an instruction of generating a backup volume, the generator 11 copies the data of the work volume into the first region of the layered storage pool 6b or 6c to thereby generate the backup volume. Then, the mover 12 moves the data of the backup volume, the data being stored in the first region, to the second region in the lower layer than that of the first region by the mover 12. When another instruction of generating a backup volume is received under a state where the data of the backup volume is stored in the second region, the releaser 13 releases the data of the backup volume stored in the second region.

As the above, if the storage pool 6b or 6c serving as a copy destination in the various backup schemes such as OPC has layering, the backup device 10 of the first embodiment may move the data of a backup volume to a subordinate low-access-speed layer (rearrangement) immediately after the completion of the copying. Namely, using the characteristics of the copying function of the OPC or other schemes, the backup device 10 enhances the using efficiency of the first region, which is higher in access speed, without collection and analysis of performance information of the copy destination. This makes it possible to improve the performance of the entire storage system and to efficiently rearrange the storage automatically. If the copy is carried out among multiple storage devices 4, the copy-destination storage device 4 may omit a function of collecting performance information.

Besides, since the backup device 10 releases the physical data region (second region) allocated to the logical data region of the backup volume, the generator 11 generates a future backup volume that is to be generated in response to a later instruction of generating in the first region, which is a superordinate layer of the second region. Accordingly, a backup volume can be generated in the first region high in access speed, that is, data rearrangement, at the timings of, for example, the start, the end, and the restart of backup in various schemes such as OPC. This may prevent the processing speed related to the backup from declining, so that the decline in performance of the storage system 1 can be avoided.

For the above, the backup device 10 of the first embodiment makes it possible to prevent the performance of the storage system 1 from declining when a volume is being backed up into the layered storage pool 6b or 6c.

(2) Modification:

The above first embodiment assumes that the mover 12 moves the data in the physical data region of the backup volume to the lowest layer in the course of the various backup schemes such as OPC. The manner of moving the data is however not limited to this.

The mover 12 according to this modification determines a layer to which the data of a backup volume is to be moved in accordance with various factors of the capacity of a copy destination, such as an available capacity of a high-access-speed layer of the copy destination or the available capacity of the entire layered storage pool 6b or 6c.

For example, various backup schemes such as OPC need the copy-destination layered storage pool 6b or 6c to have an available physical capacity of Tier 0 high in access speed to cover the size of the work volume while need an available physical capacity of the entire pool including Tiers 1 and 2 lower in access speed to cover the entire backup volume. Accordingly, unless the available physical capacity of Tier 0 high in access speed comes below the total volume of the work volume, the mover 12 does not have to move the backup volume.

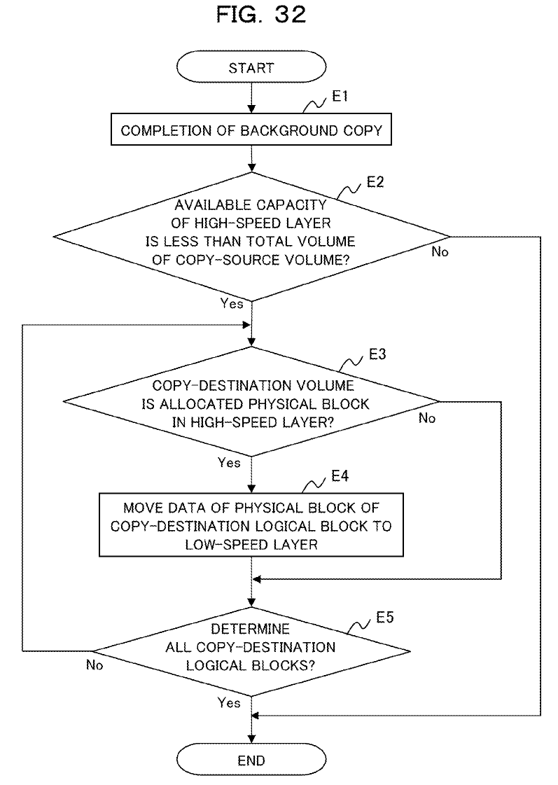

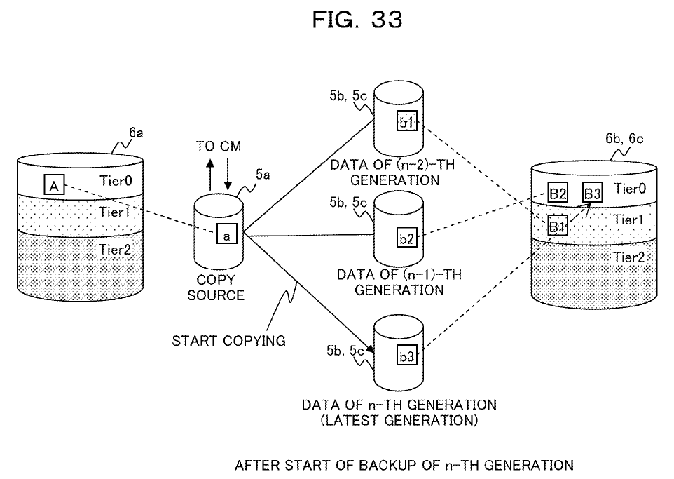

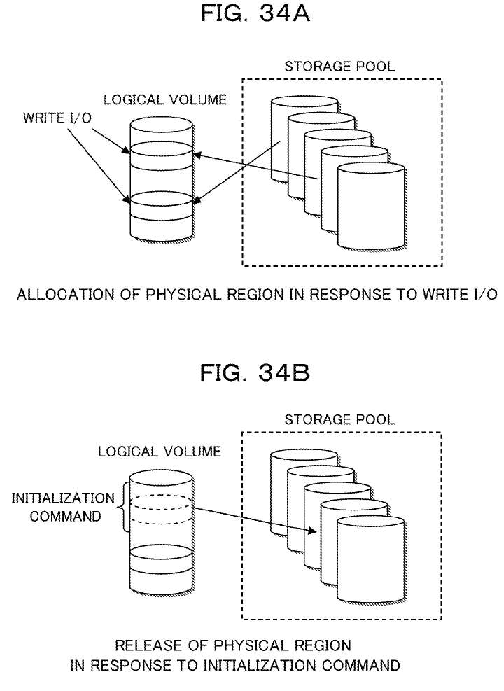

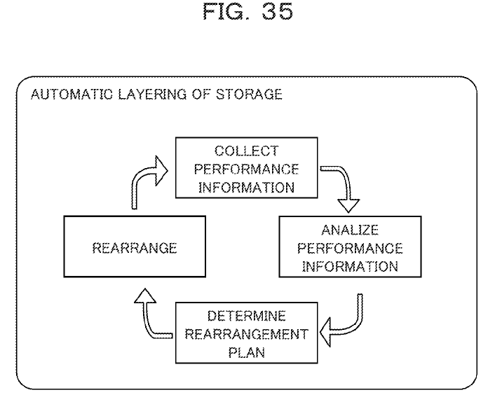

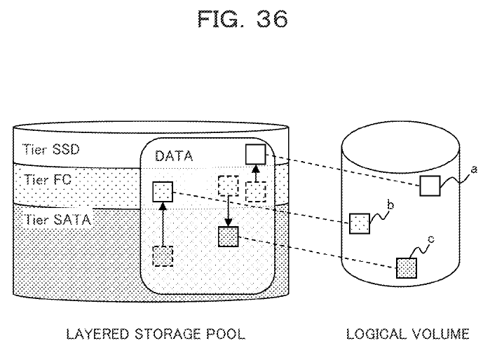

Hereinafter description will now be made in relation to the configuration and the operation of the mover 12 of this modification with reference to FIGS. 32 and 33. FIG. 32 is a flow diagram denoting a succession of procedural steps of moving a backup volume according to this modification and FIG. 33 is a diagram illustrating the procedure of moving the backup volume in the backup device 10 of this modification.

The parts and elements except for the mover 12 of this modification are identical or substantially identical to those in the backup device 10 of the first embodiment in FIG. 3, so repetitious description thereof is omitted here. Steps E2-E5 of FIG. 32 are substitutes for steps S22-S24 in the OPC/QOPC scheme of FIG. 19; steps C11-C13 in the SnapOPC+ scheme of FIG. 23; or steps D52-D54 in the EC/REC scheme of FIG. 30. When steps C11-C13 in the SnapOPC+ scheme of FIG. 23 are substituted by steps E3-E5 of FIG. 32, the determination and processing on a copy-destination logical block are sufficiently performed on a copy-destination logical block of the (n−1)-th generation.

As illustrated in FIG. 32, upon completion of background copy in, for example, the OPC/QOPC scheme (step E1), the mover 12 determines whether an available capacity of a high-access-speed layer is less than the total capacity of the work volume (step E2). If the available capacity of the high-access-speed layer is less than the total capacity of the work volume (Yes route in step E2), the mover 12 determines whether a copy-destination logical block is allocated a physical block in the high-access-speed layer (step E3). If the copy-destination logical block is allocated a physical block in the high-access-speed layer (Yes route in step E3), the mover 12 moves the data of the physical block allocated to the copy-destination logical block to a physical block in a low-access-speed layer (i.e., Tier 1 or Tier 2) (step E4) and the procedure moves to step E5.

In step E5, the mover 12 determines whether all the copy-destination blocks are determined whether the respective logical blocks are allocated respective physical blocks in the high-access-speed layer. If not all the copy-destination logical blocks undergo the determination (No route in step E5), the procedure moves to step E3 to determine whether the next copy-destination logical block is allocated a physical block in the high-access-speed layer. In contrast, if all the copy-destination logical blocks undergo the determination (Yes route in step E5), the moving the physical data region of the backup volume by the mover of this modification is completed.

Here, if the available capacity of the high-access-speed layer is equal to or more than the total capacity of the work volume (No route in step E2), the data in the physical data region of the backup volume does not have to be moved from a high-access-speed layer to a low-access-speed layer. For this reason, the mover 12 terminates the procedure without moving the data of the physical data region. Besides, if the copy-destination logical block is not allocated a physical block in the high-access-speed layer (No route in step E3), the procedure skips step E4 and directly moves to step E5.

Alternatively, the layer of the destination in step E4 in this modification may be preferentially allocated in the order of higher layers by the mover 12. For example, the CM 3 may set thresholds of available capacities of the respective layers and the mover 12 may compare the available capacity of a layer and the threshold of the same layer in the order of higher layers and determine a highest layer satisfying the available capacity equal to or more than the corresponding threshold to be the destination layer.

For example, as illustrated in FIG. 33, if multiple backup volumes are generated for a single work volume, in other words, if backup volumes of multiple generations in units of, for example, days or weeks, only the backup volume of the latest generation is to be copied. Namely, the backup volumes of the past generations are backup data already copied, which therefore do not affect the processing of the CM 3 on the work volume. The above operation manner is related to the SnapOPC+ scheme, but other schemes such as OPC, QOPC, EC and REC may be applied this operation manner.

In order to achieve the operation manner of FIG. 33 in various backup schemes such as OPC, the mover 12 moves backup data of the past generations to the higher-access-speed layers of Tier 0 or Tier 1 when the available physical capacity of Tier 0 high in access speed does not come below the total volume of the entire work volume.

Determining the destination of moving a backup volume in accordance with the capacity of the copy destination in the above manner achieves the same effects as those of the first embodiment and further makes it possible to efficiently rearrange the data according to the state of using the copy-destination layered storage pool 6b or 6c.

(3) Others:

A preferable embodiment and a modification of the present invention are described as the above. However, the present invention is by no means limited to the above first embodiment and various changes and modifications can be suggested without departing from the gist of the present invention.

For example, the layered storage pools 6 of the first embodiment and the modification each assume to have a physical volume consisting of the three layers of Tier 0 through Tier 2 in total. Alternatively, the layered storage pools 6 may each have a physical volume consisting of two layers or four or more layers.

The above description of the first embodiment and the modification assumes the backup is carried out in the respective schemes of OPC, QOPC, SnapOPC+, EC, and REC. Alternatively, the storage system 1 may carry out backup in combination of two or more of the above schemes. For example, if a backup volume is generated by copying the work volume of the storage device 4a to the storage device 4b in the SnapOPC+ scheme, the work volume or the backup volume may be regarded as a volume to be backed up and may be further copied into the storage device 4c in the REC scheme. In this alternative manner, the above processes of the CM 3 of the first embodiment and the modification can be applied.

Further, the functions as the generator 11 (the copier 11a and the suspender 11b), the mover 12, the releaser 13, the canceller 14, and the layer controller 15 may be integrated or distributed in any combination.

The CM 3 serving as a controller has the functions of the generator 11 (the copier 11a and the suspender 11b), the mover 12, the releaser 13, the canceller 14, and the layer controller 15. The program to achieve the functions of the controller may be provided in the form of being stored in a computer-readable recording medium such as a flexible disk, a CD (e.g., CD-ROM, CD-R, CD-RW), and a DVD (e.g., DVD-ROM, DVD-RAM, DVD-R, DVD+R, DVD-RW, DVD+RW, HD DVD), a Blu-ray disk, a magnetic disk, an optical disk, and a magneto-optical disk. The computer reads theprogr am from the recording medium and stores the program into an internal or external memory for future use. The program may be stored in a storage device (recording medium), such as a magnetic disk, an optical disk, and a magneto-optical disk, and may be provided to a computer from the storage device through a communication line.

In achieving the functions of the controller, the program stored in an internal memory (in the first embodiment, the memory 34, the storage device 4 or a non-illustrated ROM) is executed by the microprocessor (in the first embodiment, the CPU 33) in a computer. Alternatively, the computer may read the program recorded in a recording medium using a reading device and execute the read program.

Here, a computer is a concept of a combination of hardware and an Operating System (OS), and means hardware which operates under control of the OS. Otherwise, if a program operates hardware independently of an OS, the hardware corresponds to the computer. Hardware includes at least a microprocessor such as a CPU and means to read a computer program recorded in a recording medium. In the first embodiment, the backup device 10 (the CM 3) serves to function as a computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A backup device that generates a backup volume of an object volume, the backup device comprising:
a first storage device that stores data of the backup volume; and
a processor that
generates, upon receipt of an instruction of generating the backup volume, the backup volume by copying data of the object volume into a first region of the first storage device,
moves the data of the backup volume, the data being stored in the first region of the first storage device, to a second region of the first storage device, the second region being subordinate to the first region, and
releases, upon receipt of an instruction of generating the backup volume under a state where the data of the backup volume is stored in the second region, the data of the backup volume from the second region.

2. The backup device according to claim 1 further comprising a container that contains an allocation management table that manages allocation of a logical data region of the backup volume and a physical data region of the first storage device, wherein
the processor sets, when the data of the backup volume, the data being stored in the second region, is to be released, an invalid value for the physical data region allocated to the logical data region of the backup volume in the allocation management table.

3. The backup device according to claim 1, wherein
upon receipt of an instruction of generating the backup volume for the i-th time (where i is an integer of two or more),
the processor
releases data in the backup volume, the data being corresponding to data updated in the object volume for a time period from receipt of an instruction of generating the backup volume for the (i−1)-th time to the receipt of the instruction of generating for the i-th time, and
generates the backup volume by copying the data updated in the object volume into the first region of the first storage device.

4. The backup device according to claim 1, wherein:
the first storage device stores a plurality of the backup volumes of m generations (where, is an integer of two or more);
upon receipt of an instruction of generating a backup volume of the n-th generation (where, is an integer of two or more),
the processor
moves data in the backup volume of the (n−1) generation, the data being stored in the first region of the first storage device, to the second region; and
generates the backup volume of the n-th generation by copying data of the object volume, the data before updating, the data being related to data to be updated for a time period from the receipt of the instruction of generating the backup volume of the n-th generation to receipt of an instruction of generating a backup volume of the (n+1)-th generation, into the first region of the first storage device.

5. The backup device according to claim 4, wherein
upon receipt of the instruction of generating the backup volume of the n-th generation (where, n>m),
the processor determines a generation of the backup volume to be released on the basis of the value n and releases the data in the backup volume of the determined generation to be released from the second region.

6. The backup device according to claim 1, further comprising a second storage device that stores the data of the object volume, wherein
the first region is included in the first storage device and is in a layer the same as or higher than a layer that stores data to be backed up of the object volume in the second storage device

7. The backup device according to claim 1, wherein the processor,
in the generating of the backup volume,
keeps an equivalent state of the first region to a region storing the data of the object volume by copying the data of the object volume into the first region of the first storage device, and
upon receipt of an instruction of suspending the equivalent state,
suspends the copying of the data of the object volume to the first region of the first storing device.

8. The backup device according to claim 7, wherein
upon receipt of an instruction of resuming the copying suspended,
the processor
releases, in the releasing, data corresponding to data updated in the object volume for a time period from the suspending to the receipt of the instruction of resuming, from the second region, and
moves, in the moving, data in the second region, the data corresponding to data not updated in the object volume from the suspending to the receipt of the instruction of resuming, to the first region.

9. The backup device according to claim 8, wherein
the processor further cancels the suspend of the copying when the data in the backup volume is released, and
upon cancelling the suspending the copying, the processor copies data updated in the object volume for the time period from the suspending to the receipt of the instruction of resuming, to the first region of the first storage device.

10. The backup device according to claim 7, further comprising a second storage device that stores the data of the object volume, wherein:
the first region is included in the first storage device and is in a layer the same as or higher than a first layer that stores data to be backed up of the object volume in the second storage device; and
the processor
controls the layer to store the data of the object volume among a plurality of layers of the second storage device, and
moves, when the data to be backed up of the object volume is moved from the first layer to a second layer in the second storage device in the controlling under the equivalent state kept by the copying, data copied to the first region of the first storage device by the copying to a third region being in a layer of the first storage device and being the same as or higher than the second layer that stores the data of the object volume after the moving in the second storage device.

11. The backup device according to claim 1, wherein the processor determines, in the moving, the second region to which the data of the object volume is moved from the first region, according to the capacity of the first storage device.

12. A method of backup comprising:
in a processor
generating, upon receipt of an instruction of generating a backup volume, the backup volume by copying data of an object volume into a first region of a first storage device;
moving the data of the backup volume, the data being stored in the first region of the first storage device, to a second region of the first storage device, the second region being subordinate to the first region; and
releasing, upon receipt of an instruction of generating the backup volume under a state where the data of the backup volume is stored in the second region, the data of the backup volume from the second region.

13. The method according to claim 12, further comprising
in the generating, upon receipt of an instruction of generating the backup volume for the i-th time (where i is an integer of two or more),
releasing data in the backup volume, the data being corresponding to data updated in the object volume for a time period from receipt of an instruction of generating the backup volume for the (i−1)-th time to the receipt of the instruction of generating for the i-th time; and
generating the backup volume by copying the data updated in the object volume into the first region of the first storage device.

14. The method according to claim 12, wherein:
the first storage device includes a plurality of the backup volumes of m generations (where, m is an integer of two or more);
the method further comprises
in the moving, upon receipt of an instruction of generating a backup volume of the n-th generation (where, n is an integer of two or more),
moving data in the backup volume of the (n−1) generation, the data being stored in the first region of the first storage device, to the second region, and
generating the backup volume of the n-th generation by copying data of the object volume, the data before updating, the data being related to data to be updated for a time period from the receipt of the instruction of generating the backup volume of the n-th generation to receipt of an instruction of generating a backup volume of the (n+1)-th generation, into the first region of the first storage device.

15. The method according to claim 14, further comprising
in the releasing, upon receipt of the instruction of generating the backup volume of the n-th generation (where, n>m),
determining a generation of the backup volume to be released on the basis of the value n and releases the data in the backup volume of the determined generation to be released from the second region.

16. The method according to claim 12, further comprising:
in the generating
keeping an equivalent state of the first region to a region storing the data of the object volume by copying the data of the object volume into the first region of the first storage device; and
upon receipt of an instruction of suspending the equivalent state,
suspending the copying of the data of the object volume to the first region of the first storing device.

17. The method according to claim 16, further comprising:
releasing, upon receipt of an instruction of resuming the copying in the releasing, data corresponding to data updated in the object volume for a time period from the suspending to the receipt of the instruction of resuming, from the second region, and
moving, in the moving, data in the second region, the data corresponding to data not updated in the object volume from the suspending to the receipt of the instruction of resuming, to the first region.

18. The method according to claim 17, further comprising:
cancelling the suspend of the copying when the data in the backup volume is released; and
upon cancelling the suspending the copying,
copying data updated in the object volume for the time period from the suspending to the receipt of the instruction of resuming, to the first region of the first storage device.

19. The method according to claim 16, wherein:
the first region is included in the first storage device and is in a layer the same as or higher than a first layer that stores data to be backed up of the object volume in a second storage device that stores the data of the object volume;
the method further comprises
controlling the layer to store the data of the object volume among a plurality of layers of the second storage device, and
moving, when the data to be backed up of the object volume is moved from the first layer to a second layer in the second storage device in the controlling under the equivalent state kept by the copying, data copied to the first region of the first storage device by the copying to a third region being in a layer of the first storage device and being the same as or higher than the second layer that stores the data of the object volume after the moving in the second storage device.

20. A computer-readable recording medium having stored therein a program for causing a computer a process for backup, the process comprising:
generating, upon receipt of an instruction of generating a backup volume, the backup volume by copying data of an object volume into a first region of a first storage device;
moving the data of the backup volume, the data being stored in the first region of the first storage device, to a second region of the first storage device, the second region being subordinate to the first region; and
releasing, upon receipt of an instruction of generating the backup volume under a state where the data of the backup volume is stored in the second region, the data of the backup volume from the second region.
